(19) United States
(12) Patent Application Publication
(10) Pub. No.: US 2013/0262269 A1
(43) Pub. Date: Oct. 3, 2013

(54) SYSTEM FOR ELECTRONIC TRANSACTIONS

(71) Applicant: James Shaun O'Leary, Cairns (AU)

(72) Inventor: James Shaun O'Leary, Cairns (AU)

(21) Appl. No.: 13/808,367

(22) PCT Filed: Jul. 6, 2011
(86) PCT No.: PCT/AU2011/000850

§ 371 Date: Jun. 5, 2013

Related U.S. Application Data
(60) Provisional application No. 61/361,573, filed on Jul. 6, 2010.
(60) Provisional application No. 61/375,911, filed on Aug. 23, 2010.

(30) Foreign Application Priority Data
Jul. 6, 2010 (AU) 2010902986

(51) Int. Cl. G06Q 30/06

(52) U.S. Cl. CPC G06Q 30/0635
USPC 705/26.81

(57) ABSTRACT

An electronic transaction system for facilitating electronic transactions between merchants and buyers includes a shopping cart module configured to provide a merchant portal for merchants to display details of goods for sale and to provide a buyer portal for buyers to select and purchase the goods. A shipping module is configured to provide buyers automatically with details of a shipping service of at least one shipper for shipping the goods selected for purchase by the buyer, and to communicate shipping orders automatically to the at least one shipper following checkout of goods for purchase by the buyer. A banking module is configured for providing a payment gateway for facilitating distribution anti transfer of funds amongst merchants, shippers, and a system provider. An administration module is configured for executing a merchant registration process for enabling a merchant to register with the system provider.

### CROSS REFERENCE TO RELATED APPLICATIONS

This application is a continuation of International Application No. PCT/AU2011/000850 filed Jul. 6, 2011, which claims priority to U.S. Provisional Application No. 61/361,573 filed Jul. 6, 2010 and Australian Application No. 2010902986 filed Jul. 6, 2010 and U.S. Provisional Application No. 61/375,911 filed Aug. 23, 2010, the disclosures of which are hereby incorporated herein by reference.

### FIELD OF THE INVENTION

This invention relates to a system for electronic transactions.

### BACKGROUND TO THE INVENTION

Online electronic transactions have become increasingly popular over the years. There is a steady growth of customers moving from bricks and mortar shopping to online shopping. As a result, a number of different web-based applications have been developed to facilitate such trade. For example, there are a number of sophisticated shopping cart applications. These allow sellers effectively to manage an online business by providing a portal for customers wishing to purchase their products.

Shopping cart applications, one of which is known as “X-Cart”, provide a website for merchants which are highly customizable. Furthermore, merchants can select the payment gateways to be coupled with the shopping cart application to provide an online transaction system. In order to access the service, a merchant must first open an account with the shopping cart provider. Then, in a separate operation, open an account with a payment gateway. Such gateways facilitate the transfer of monies between the merchant and the customer in a secure fashion and environment. Many shopping cart applications are configured to be capable of integration with such gateways. As a result, the customer can navigate to the gateway selected by the merchant once a product or service has been selected for purchase.

A problem with such arrangements is that merchants need to interface with two service providers. This can create an excessive administrative burden. Furthermore, it is often difficult for merchants and buyers to arrive at a resolution if problems arise. That is because there is no central location or meeting point for the resolution of issues.

Online market places have established a reputation as virtual locations where almost anything can be purchased. However, most of the transactions require the purchaser or buyer to make a financial commitment, hope that the products arrive in good order and deal with any problems after the fact. Many consumers have had to expose themselves to “non-bank-verified” merchants without credit history or background checks. In an attempt to address this, the consumer has had to deal with ambiguous feedback ratings, fraudulent sellers and long waiting periods for any issues to be resolved.

### SUMMARY OF THE INVENTION

The invention provides a system for electronic transactions between merchants and buyers, the system comprising:
a shopping cart module configured to provide a merchant portal for merchants to display details of goods for sale and to provide a buyer portal for buyers to select and purchase the goods;
a shipping module configured automatically to provide buyers automatically with details of a shipping service of at least one shipper for shipping the goods selected for purchase by the buyer, and to communicate shipping orders automatically to the at least one shipper following checkout of goods for purchase by the buyer;
a banking module for providing a payment gateway for facilitating distribution and transfer of funds amongst merchants, shippers, and a system provider; and
an administration module configured for executing a merchant registration process for enabling a merchant to register with the system provider, in which the registration process with the system provider includes automatically registering an account for the merchant with both the shopping cart module and with the payment gateway.

The administration module may be configured so that the merchant registration process can include receiving merchant application information from a web form, storing the merchant application information, associated a fee structure with the merchant application information, and writing at least the merchant application information to the banking module.

The administration module may be configured so that information about a commission based fee structure is generated and assigned to the merchant application information, and information about the commission based fee structure and a request form for information needed for registration with the payment gateway is written to a merchant computer.

The administration module may be configured so that the merchant registration processes can further include sending the information about the commission based fee structure and a request form for information needed for registration with the payment gateway to the merchant computer.

The administration module may be configured so that the merchant registration process can include receiving the information needed for registration with the payment gateway from the merchant and information for registration of the merchant with the payment gateway can be written to the banking module for processing.

The administration module may be configured so that the merchant registration process can include receiving a merchant identification code from the banking module which has been generated in response to approval of the new merchant application information for registration of the merchant with the payment gateway.

Further, the administration module may be configured so that the merchant registration process can include storing the merchant identification code in relation to the merchant information, and creating a merchant account for the merchant with the shopping cart module.

The administration module may be configured so that the merchant registration process can include sending shopping cart account information to a merchant computer, the shopping cart account information including any one of a user name, password, account activation token, a link to an account activation web page, and a user guide.

The system may include a database module for storing information relating to commercial transactions made over the system.

The system may include a central funds holding account into which funds are deposited for goods and services purchased by buyers.

The administration module may include a sweeping module which is configured for executing a sweeping process which includes retrieving information about the commercial transactions from the database module, determining the distribution amounts of funds from the central holding account to the merchants, shippers, and the e-commerce service provider, and compiling payment instructions for forwarding to the banking module for distributing funds over the payment gateway. The sweeping module may be configured for executing a sweeping process at predetermined intervals, such as at least once a day.

The sweeping module may be configured to compile payment instructions for merchants, shippers, and the system provider, at different times in the transaction process. The sweeping module may be configured first to determine eligibility of payment of any one of the merchant, shipper, and the system provider before executing the sweeping process in relation to transactions relating to any one of the merchant, shipper, and the system provider respectively.

The administrative module may be configured for flagging a merchant as eligible for payment after goods that are purchased from the merchant are delivered and the database module is updated to indicate that the goods are delivered.

The administrative module may be configured for flagging a shipper as eligible for payment after a merchant confirms the order for shipment with the shipper and the database module is updated to indicate that shipment of goods is confirmed.

The administrative module may be configured for flagging the provider as eligible for payment after funds for a transaction are received in the central funds holding account.

The sweeping module may be configured for generating a data file that includes the payment instructions, information in the data file being presentable on a user interface for review by a user, and for editing by a user with the administration module prior to sending of the data file to the banking module.

The banking module may be configured to generate a disbursement and exception report for sending to the administrative module subsequent to executing the payment instructions, which disbursement and exception report includes information that flags successful transaction and that flags unsuccessful transactions.

The system may include a customer relations module that is configured to provide a communication pathway between merchants and buyers to facilitate the resolution of disputes that may arise between merchants and buyers.

The customer relations module may be configured to generate and manage an issue resolution process for resolving issues between merchants and buyers, the process comprising:
receiving information from a buyer about the issue, and filtering the information to determine if the issue is technical, product, or account related;
sending the information to a computer associated with a support staff member; and
establishing the communications pathway for sending information between the relevant merchant and buyer.

The invention also provides a method for facilitating commercial transactions between merchants and buyers with an electronic transaction system, the method comprising:
with a shopping cart module, providing a merchant portal for merchants to display details of goods for sale and a buyer portal for buyers to select and checkout goods for purchase;
with a shipping module, providing buyers automatically with details of a shipping service of at least one shipper for shipping the goods selected for purchase by the buyer, and writing shipping orders automatically to the at least one shipper following checkout of goods for purchase by the buyer;
with a banking module, providing a payment gateway facilitating distribution and transfer of funds amongst merchants, shippers, and a system provider; and
with an administration module, executing a merchant registration process for enabling a merchant to register with the system provider, in which the registration process with the system provider includes automatically registering an account for the merchant with both the shopping cart module and with the payment gateway.

The invention also provides a computer-readable medium tangibly embodying instructions executable by a processor for facilitating commercial transactions between merchants and buyers, the instructions comprising instructions for:
with a shopping module, providing a merchant portal for merchants to display details of goods for sale and a buyer portal for buyers to select and purchase the goods;
with a shipping module, providing buyers automatically with details of a shipping service of at least one shipper for shipping the goods selected for purchase by the buyer, and writing shipping orders automatically to the at least one shipper following checkout of goods for purchase by the buyer;
with a banking module, providing a payment gateway for facilitating distribution and transfer of funds amongst merchants, shippers, and a system provider; and
with an administration module, executing a merchant registration process for enabling a merchant to register with the system provider, such that the registration process with the system provider includes automatically registering an account for the merchant with both the shopping cart module and with the payment gateway.

The merchant registration process may include receiving merchant application information from a web form, storing the merchant application information, and generating a flag associated with the merchant application information indicating that a new merchant application is received.

The merchant registration process may include generating information about a commission based fee structure and to assign the information about the commission based fee structure with the administrative module to the new merchant application. The merchant registration processes may further include sending the information about the commission based fee structure and a request form for information needed for registration with the payment gateway to the merchant computer.

The merchant registration process may include receiving information needed for registration with the payment gateway from the merchant, generating application information for registration of the merchant with the payment gateway, and forwarding the application information for registration of the merchant with the payment gateway to the banking module for processing.

The merchant registration process may include receiving a merchant identification code from the banking module which has been generated in response to approval of the new merchant application information for registration of the merchant with the payment gateway.

Further, the merchant registration process may include storing the merchant identification code in relation to the merchant information, and creating a merchant account for the merchant with the shopping cart module.

The merchant registration process may include sending shopping cart account information to a merchant computer, the shopping cart account information including any one of a user name, password, account activation token, a link to an account activation webpage, and a user guide.

The method may include storing, in a database module, information relating to commercial transactions made over the e-commerce service provider system.

The method may include establishing a central funds holding account, in which funds paid for goods and services purchased by buyers are deposited into the central funds holding account.

The method may include executing a sweeping process with a sweeping module, which includes retrieving information about the commercial transactions from the database module, determining the distribution amounts of funds from the central holding account to the merchants, shippers, and the system provider, and compiling payment instructions for forwarding to the banking module for distributing funds over the payment gateway. The sweeping module may be configured for executing a sweeping process at least once a day.

The method may include configuring the sweeping module to compile payment instructions for merchants, shippers, and the e-commerce service provider, at different times in the transaction process. The sweeping process may include first determining eligibility of payment of any one of the merchant, shipper, and the e-commerce service provider before executing the sweeping process in relation to transactions relating to any one of the merchant, shipper, and the system provider respectively.

The method may include, with the administrative module, first flagging a merchant as eligible for payment after goods that are purchased from the merchant are delivered and the database module is updated to indicate that the goods are delivered before the sweeping process starts. Similarly, the method may include flagging a shipper as eligible for payment after a merchant confirms the order for shipment with the shipper and the database module is updated to indicate that shipment of goods is confirmed.

The method may include flagging the system provider as eligible for payment after funds for a transaction are received in the central funds holding account before a sweeping process.

The sweeping process may include generating a data file that includes the payment instructions, information in the data file being presentable on a user interface for review by a user, and for editing by a user with the administration module prior to sending of the data file to the banking module.

The method may include generating a disbursement and exception report with the banking module for sending to the administrative module subsequent to executing the payment instructions, which disbursement and exception report includes information that flags successful and unsuccessful transactions.

The method may include configuring a customer relations module to provide a communication pathway between merchants and buyers to facilitate the resolution of disputes that arise between merchants and buyers.

The method may include configuring the customer relations module to generate and manage an issue resolution process for resolving issues between merchants and buyers, the process including:
receiving information from a buyer about the issue, and filtering the information to determine if the issue is technical, product, or account related;
sending the information to a computer associated with a support staff member; and
establishing the communications pathway for sending information between the relevant merchant and buyer.

The invention extends to a computer program product which includes computer readable instructions, which when executed by a computer system, performs the method in accordance with the invention.

According to another aspect of the invention, there is provided a system for facilitating electronic transactions between merchants and buyers, the system comprising:
an administrative module for monitoring and managing the system in an automated manner;
a database module for storing data relating to electronic transactions monitored and managed by the administrative module;
a shopping cart module configured to provide an online platform for merchants to display details of the goods or services for sale and to provide a buyer portal such that buyers can select goods or services for purchase;
a shipping module configured to provide an interface for shippers so that shipping orders can be communicated to the shippers following a purchase and sale transaction; and
a banking module for generating a payment gateway facilitating transfer of funds between merchants and buyers to conclude purchases, wherein
the administrative module is configured to generate an interface for rendering by a merchant's computer, the interface being configured so that the merchant can use the interface to register with the payment gateway and so that information relating to products or services offered for sale by the merchant can be input to the database for use by the shopping cart module to offer said products and services to the buyers.

The administrative module may be configured to provide a communication pathway between merchants and buyers to facilitate the resolution of issues that may arise between merchants and buyers.

The database module may be configured so that it can be queried by the administrative module to permit the administrative module to generate reports relating to transactions carried out with the system.

The shopping cart module may be configured so that, under control of the administrative module, it can generate merchant portals which are configured to facilitate the uploading of details relating to products or services offered for sale by merchants.

The shopping cart module may further be configured so that, under control of the administrative module, it can generate buyer portals which are configured to permit buyers to view and select products or services offered for sale by merchants.

The administrative module may include, or be part of, a customer relations management (CRM) module configured for the management of transactions carried out between merchants and buyers. In particular, the CRM module may be configured for:
managing registration of merchants and buyers with the system;
bank approvals for both merchants and buyers;
payment instructions for the banking module for payments to be made to merchants and buyers;
resolution of issues between merchants and buyers; and
other issues relating to transactions.

The CRM module may be configured to generate the payment instructions in a sweeping process carried out through transaction details stored in the database module. In particular, the CRM module may be configured such that the sweeping process generates a data file containing payment instructions to be written to the banking module. In turn, the banking module may be configured to make payments to merchants, shippers and a provider of the system in accordance with the payment instructions.

The shopping cart module and the shipping module may be configured to generate data relating to package tracking such that a buyer or a merchant can track shipment of a purchased package.

The CRM module may be configured such that the registration of a merchant can include the following broad steps:
an application by a merchant using a merchant portal;
approval or disapproval of the application by the provider;
on approval, forwarding an application form to the merchant, for example, by e-mail receipt of the application form and forwarding the application form to the banking module receipt of approval or disapproval from the banking module;
on receipt of approval, creating an account for the merchant with the shopping cart module and forwarding details to the merchant so that the merchant can activate the account.

The CRM module may be configured to generate and manage an issue resolution process for resolving issues between merchants and buyers, such that the process includes the following broad steps:
determining the type of issue, that is whether the issue is technical, product or account related;
conveying details of the issue to the relevant staff associated with the administrative module;
establishing a communications pathway between a merchant and a buyer involved in the issue.

The CRM module may be configured to provide a document setting out terms and conditions of sale to a buyer, for establishing a commercial relationship between the buyer and the seller that is independent of a provider of the system. The merchant may be required to agree with the terms of the document in order to be a registered user of the system of the invention. The CRM module may be configured so that the document is available for download at the buyer portal.

According to a further aspect of the invention, there is provided a method for facilitating electronic transactions between merchants and buyers, the method comprising the steps of:
providing a shopping cart module for merchants to display details of goods or services for sale on an online platform and for buyers to select goods or services for purchase on the online platform;
providing a shipping module configured for generating an interface for shippers so that shipping orders can be communicated to the shippers following a purchase and sale transaction;
providing a banking module for generating a payment gateway facilitating transfer of funds between merchants and buyers to conclude purchases; and
generating an interface with an administrative module for rendering by a merchant's computer, the interface being configured so that the merchant can use the interface to register with the shopping cart module and with the banking module so that information relating to products or services offered for sale by the merchant can be input to the database for use by the shopping cart module to offer said products and services to the buyers.

The method may include the step of providing a communication pathway between merchants and buyers with the administrative module to facilitate the resolution of issues that may arise between merchants and sellers.

The method may include the step of generating merchant portals, under control of the administrative module, which are configured to facilitate the uploading of details relating to products or services offered for sale by merchants.

The step of generating an interface with an administrative module may be carried out with a customer relations management (CRM) module configured for the management of transactions carried out between merchants and buyers. Thus, the method may include the step of managing registration of merchants and buyers with the system of the first aspect of the invention using the CRM module. Bank approvals for both merchants and buyers may be carried out using the CRM module under control of the administrative module. The CRM module may be used to collate and send payment instructions to the banking module for payments to be made to merchants and buyers.

The step of providing a communication pathway between merchants and buyers to facilitate the resolution of issues may be carried out with the CRM module.

The method may include the step of carrying out, with the CRM module, a sweeping process on transactions stored in the database server to generate the payment instructions to be sent to the banking module for the payments to be made to merchants and buyers.

The method may also include the step of providing, with the CRM module, a document describing terms and conditions of sale to the buyer. In particular, the method may include the step of generating a link on a website so that a buyer can download the document as it relates to a particular buyer.

The invention is now described, by way of example, with reference to the accompanying drawings. The following description is for illustrative purposes only and is not intended to narrow the scope of the preceding paragraphs or the appended claims.

### BRIEF DESCRIPTION OF THE DRAWINGS

FIG. 1 represents a network topology of one embodiment of a system in accordance with the invention for commercial transactions.

FIG. 2 shows architecture of the system of FIG. 1.

FIG. 3 is a flowchart showing the various steps taken by a merchant and executed by administrative and banking modules of the system of FIG. 1 during merchant registration with the system and in accordance with a method of the invention.

FIG. 4 is a flowchart showing a process of merchant or seller registration with the system in accordance with a method of the invention.

FIG. 5 shows the steps taken by a buyer and a merchant using the system to conclude a purchase and sale in accordance with a method of the invention.

FIG. 6 is a flowchart showing a buyer purchasing process using the system in accordance with the method.

FIG. 7 is a flowchart showing a post shipping process.

FIG. 8 is an overview of a funds dispersal process, subsequent to the conclusion of a purchase and sale.

FIG. 9 is a flowchart of the funds dispersal process.

FIG. 10 is a flowchart indicating the application of commissions to be paid to the provider.

FIG. 11 is a flowchart indicating the steps taken in a sweeping process (sweep) for determining funds to be paid to a merchant.

FIG. 12 is a flowchart indicating the steps taken in a sweep for determining whether or not commissions to be paid to merchants are eligible.

FIG. 13 is a flowchart indicating the steps to be taken in a sweep for determining whether or not certain adjustment transactions are eligible.

FIG. 14 is a flowchart indicating the steps taken for calculating amounts owed to each merchant.

FIG. 15 is a flowchart indicating the steps taken in a sweep for determining funds to be paid to a shipper.

FIG. 16 is a flowchart indicating the steps taken in a sweep for determining whether or not certain shipping transactions are eligible.

FIG. 17 is a flowchart indicating the steps taken in a sweep for determining amounts owing to shippers.

FIG. 18 is a flowchart indicating the steps taken in a sweep for determining amounts owed to the provider.

FIG. 19 is a flowchart indicating the steps taken in a sweep for determining whether or not certain commission transactions are eligible.

FIG. 20 is a flowchart indicating the steps taken in a sweep for calculating an amount owing to the provider.

FIG. 21 is a flowchart indicating the steps taken in a sweep for an administrative review of sweeps.

FIG. 22 is one part of a flowchart indicating the steps taken in a help or support process.

FIG. 23 is another part of the flowchart indicating the steps taken in a help or support process.

FIG. 24 is a flowchart indicating the steps taken in a refunds process.

FIG. 25 is a screen shot of a merchant dashboard generated by a merchant module of the system for use by a merchant.

FIG. 26 is a screen shot of a payments display generated by the merchant module.

FIG. 27 is a screen shot of an order details display generated by the merchant module.

FIG. 28 is a representation of an invoice generated by the merchant module for a merchant.

FIG. 29 shows a database schema for a database forming part of the system.

FIG. 30 shows an example of a report generated by the banking module in response to payment having been made.

FIG. 31 shows an overview of the data flow of the system.

### DETAILED DESCRIPTION OF THE DRAWINGS

### Definitions

In this specification, the following definitions apply:

“Computer” means any machine or apparatus capable of carrying out data processing. The term includes a distributed network of such machines or apparatus and also a combination of such machines or apparatus which are used together to achieve a data processing function.

“Merchant” means any person or entity that is capable of transacting with another person or entity in order to sell goods or services.

“Buyer” means any person or entity that is capable of transacting with another person or entity in order to purchase goods or services.

“Provider” means any person or entity that provides use of a system, in accordance with the invention, to a merchant or buyer to facilitate commercial transactions between merchants and buyers.

“Ship” means the transport by any means of products purchased with the system of the present invention.

“Portal” means any web page or website used by buyers, merchants, shippers or providers using the system of the present invention to write data to components of the system or to receive data from components of the system.

“Goods” means any vendible product or service.

“Account” means any arrangement or agreement in terms of which one party has an agreement with another party to transact business in a particular manner.

“Web” is a descriptor used to indicate a connection with the World Wide Web (“WWW”).

“Payment Gateway” means any electronically generated application that allows a party to make a payment to another party in a remote manner, for example, via the Internet.

“Checkout” includes an electronic process whereby a buyer is presented with information concerning a proposed purchase before making that purchase.

“Shopping Cart” means an electronically generated application capable of displaying goods to be purchased to a buyer before the goods are purchased.

“Interface” means an electronically generated application that allows a user to interact in some way with a computer.

“Module” means one electronic data processing apparatus or a number of electronic data processing apparatus capable of cooperating to achieve a particular outcome.

### Network Topology

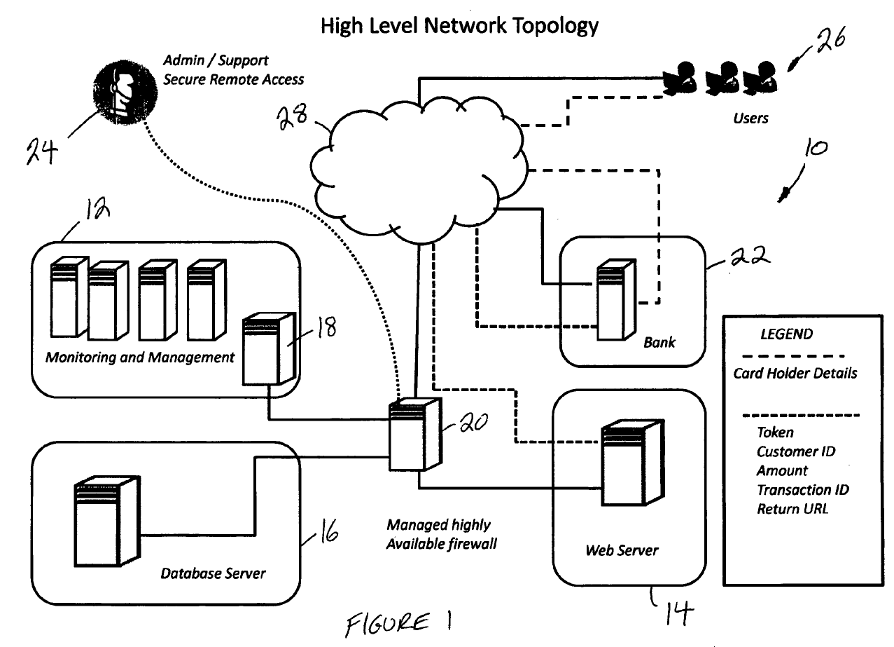

In FIG. 1, reference numeral 10 generally indicates a network topology of a system, in accordance with the invention, for electronic transactions.

The system 10 includes an administrative module 12. The administrative module 12 is configured for automated monitoring and management of the system 10. The administrative module 12 is connected to a web server 14 and to a database server 16 via a router 18 and a firewall 20 of the type which is managed and “highly available”. The database server 16 is configured to define a MySQL database.

The system 10 includes a banking module 22. The banking module 22 is connected to the administrative module 12, the web server 14 and the database server 16 via a network, in this case the Internet, indicated at 28, and the firewall 20.

The system 10 includes remote access for administrative support at 24.

Users 26 in the form of merchants and buyers can access the administrative module 12 via the Internet 28, the firewall 20 and the router 18. The users 26 can also access the banking module 22 via the Internet 28 in a secure manner. For example, the system 10 is configured to provide a secure portal so that users can provide credit card details to the banking module 22 independently of the remainder of the system 10. This ensures secure transactions for the users 26.

### System Architecture

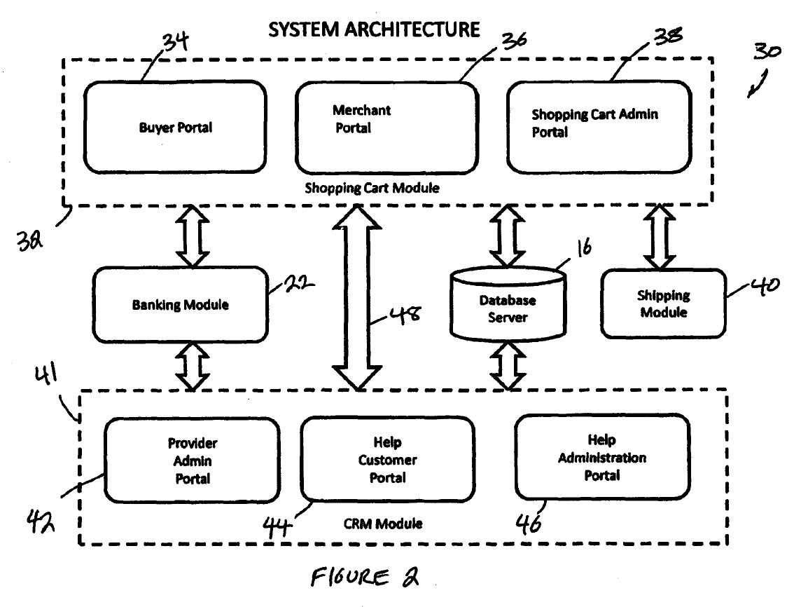

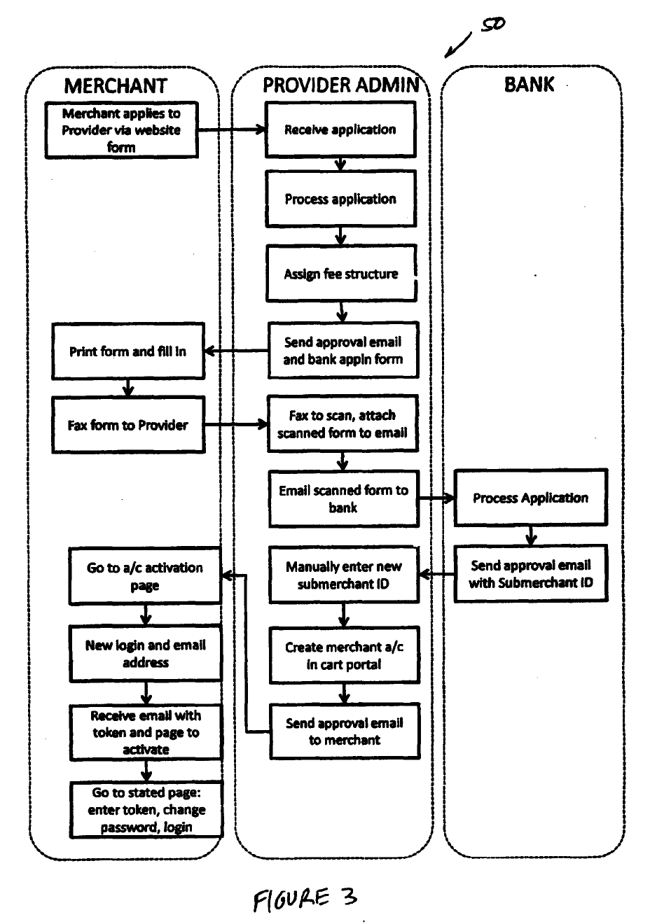

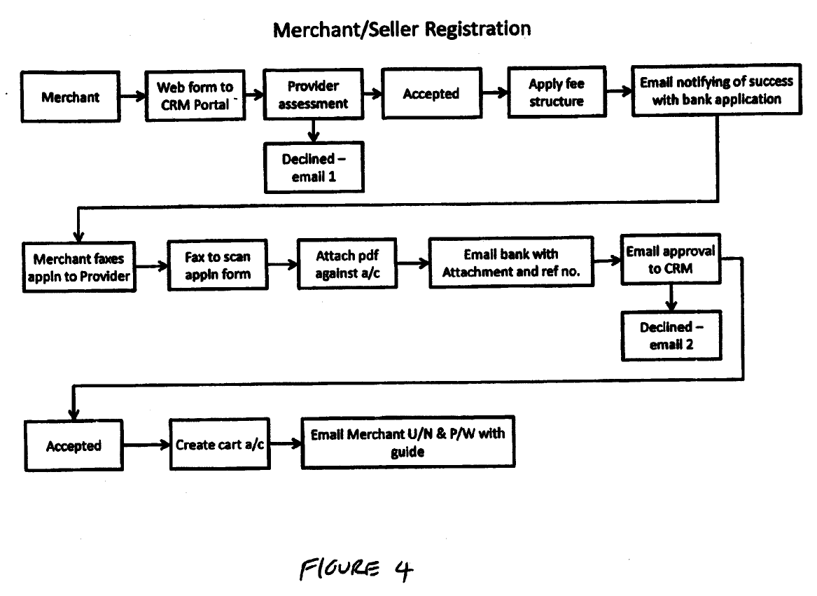

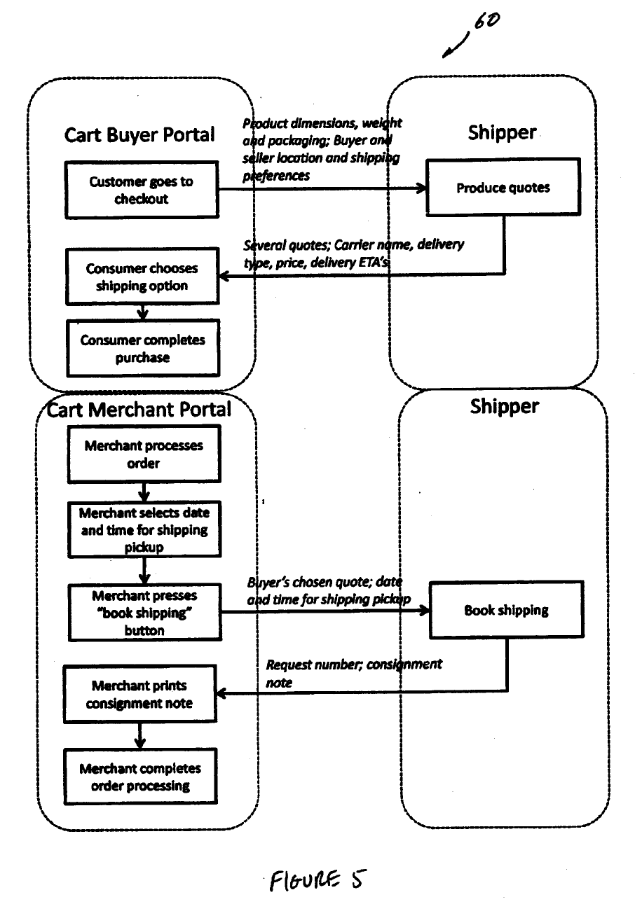

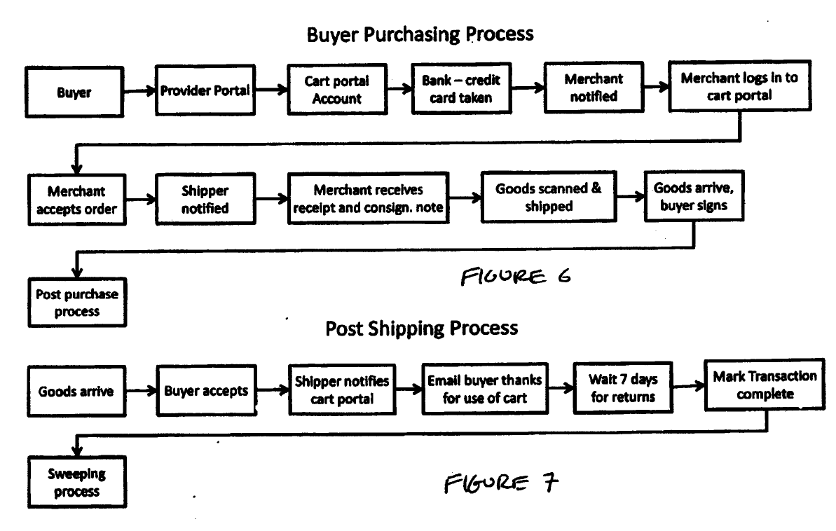

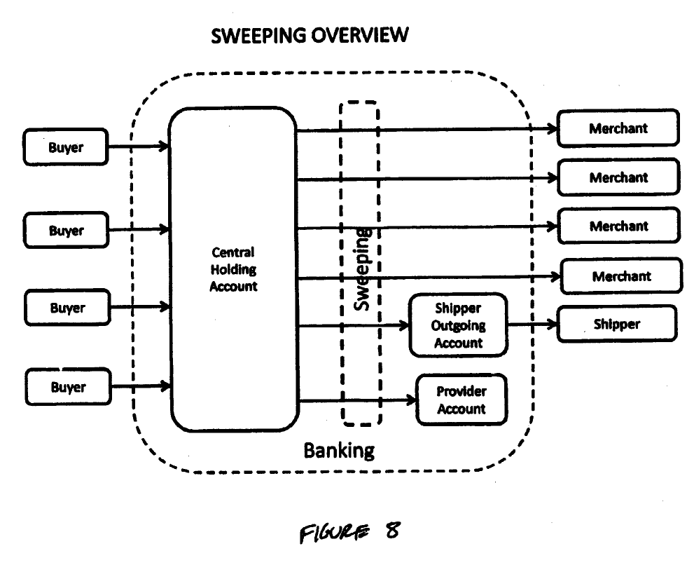

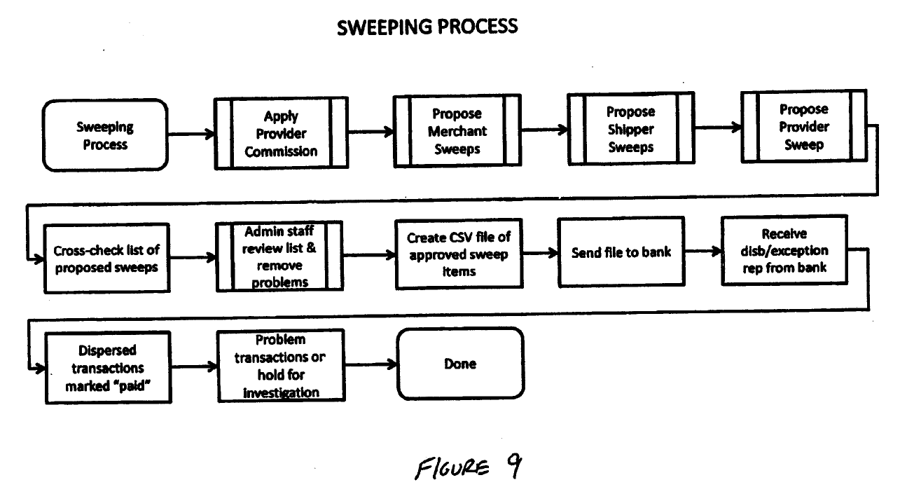

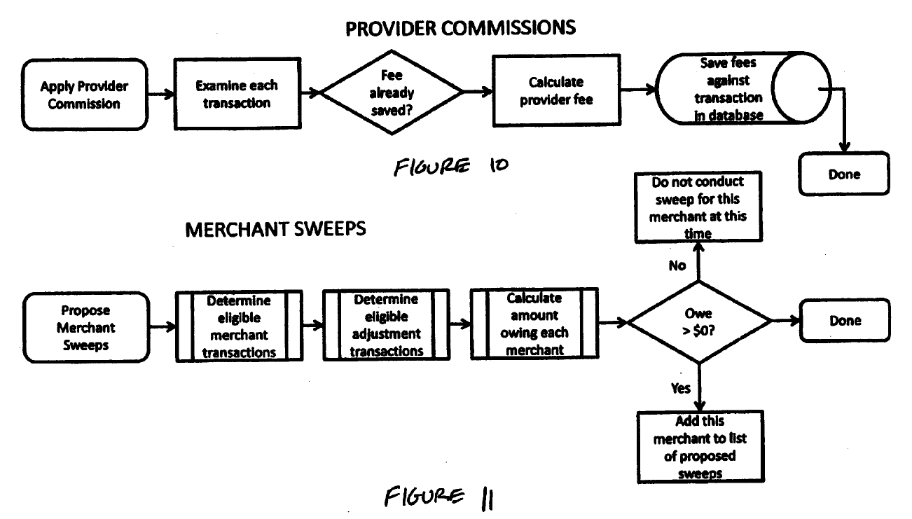

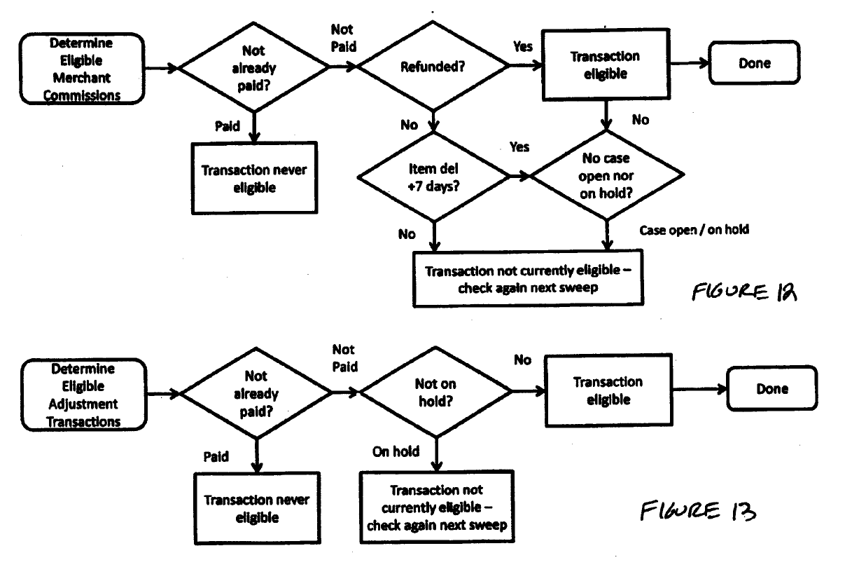

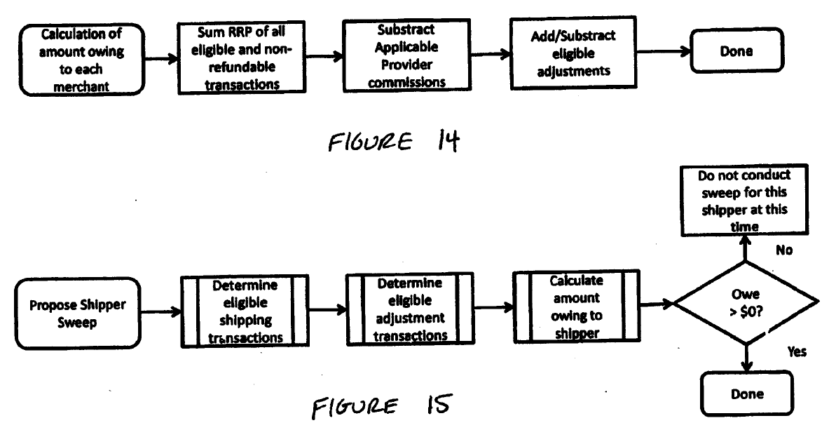

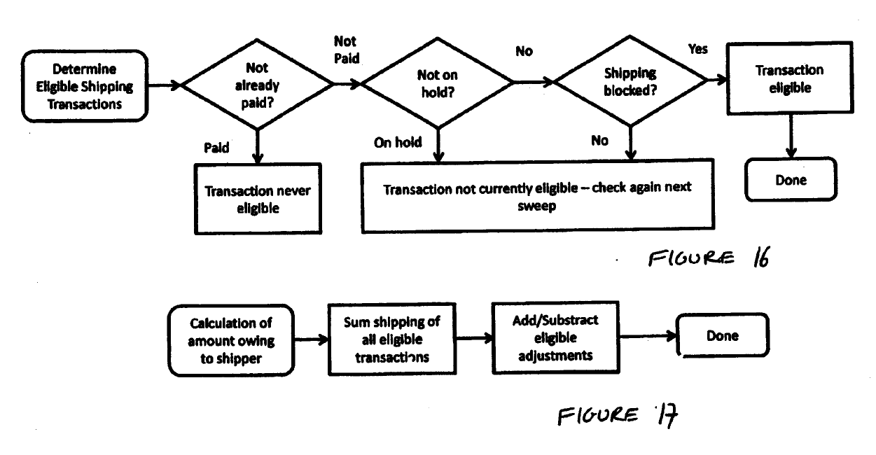

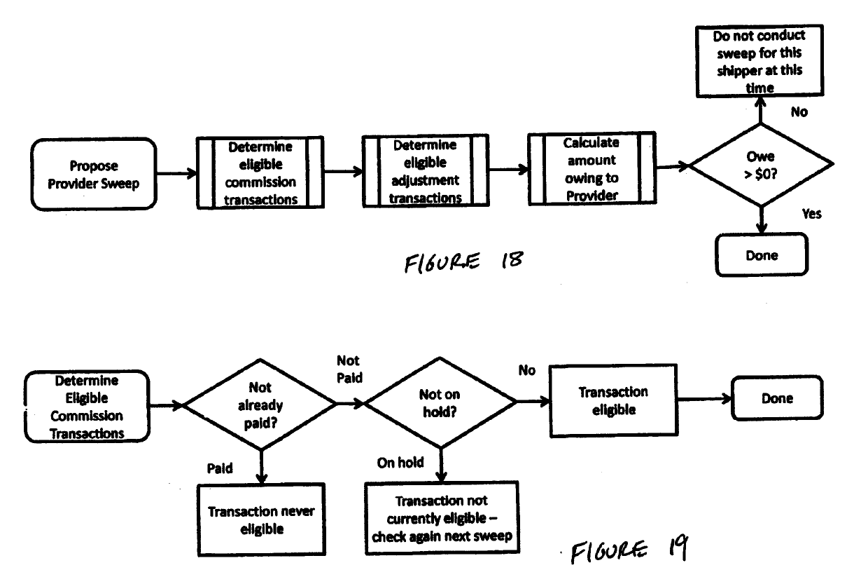

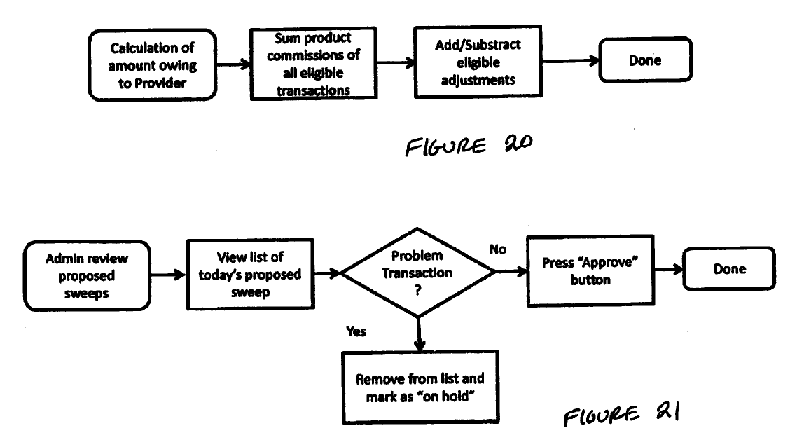

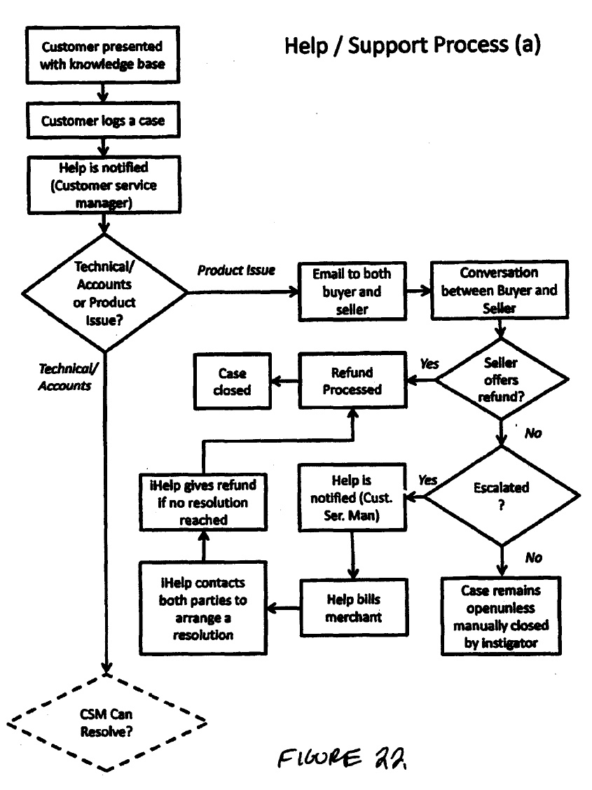

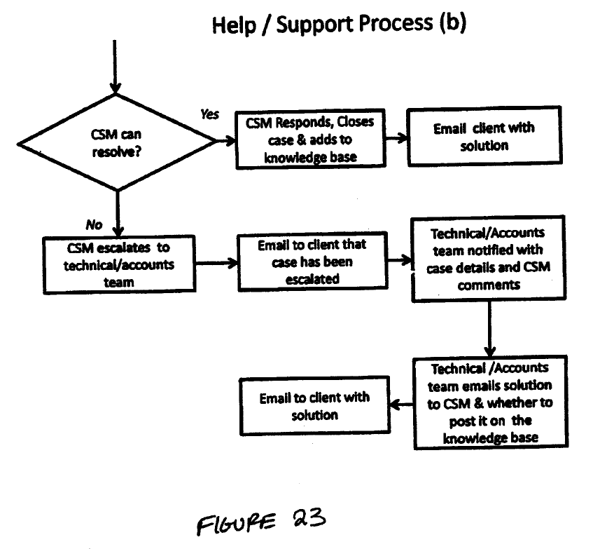

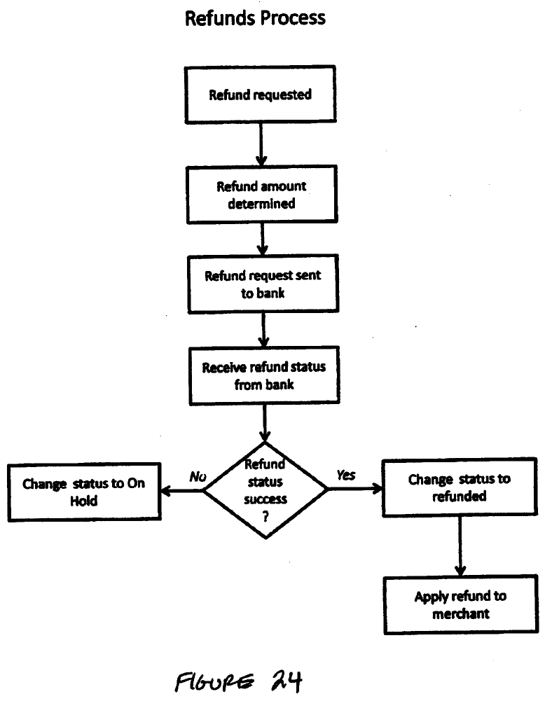

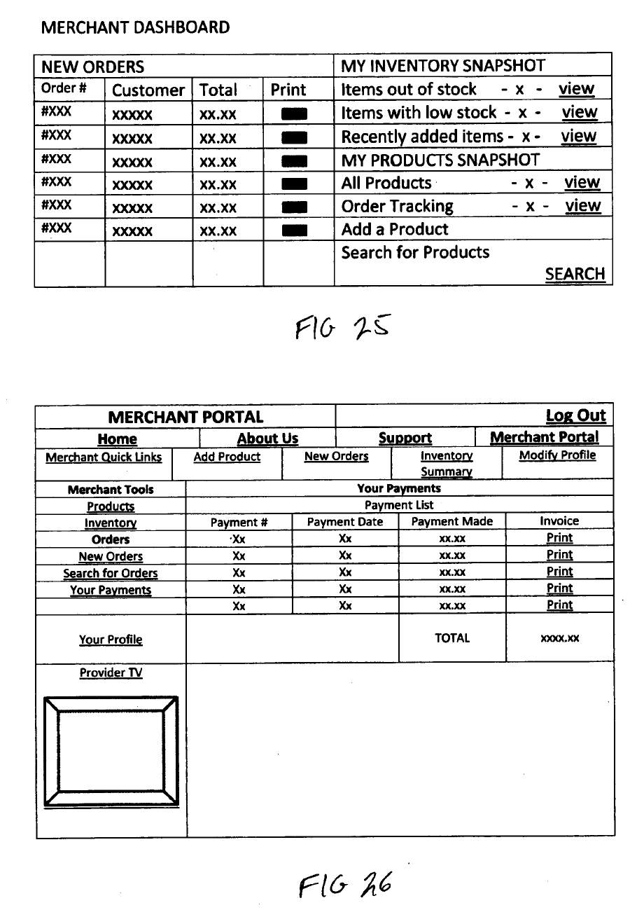

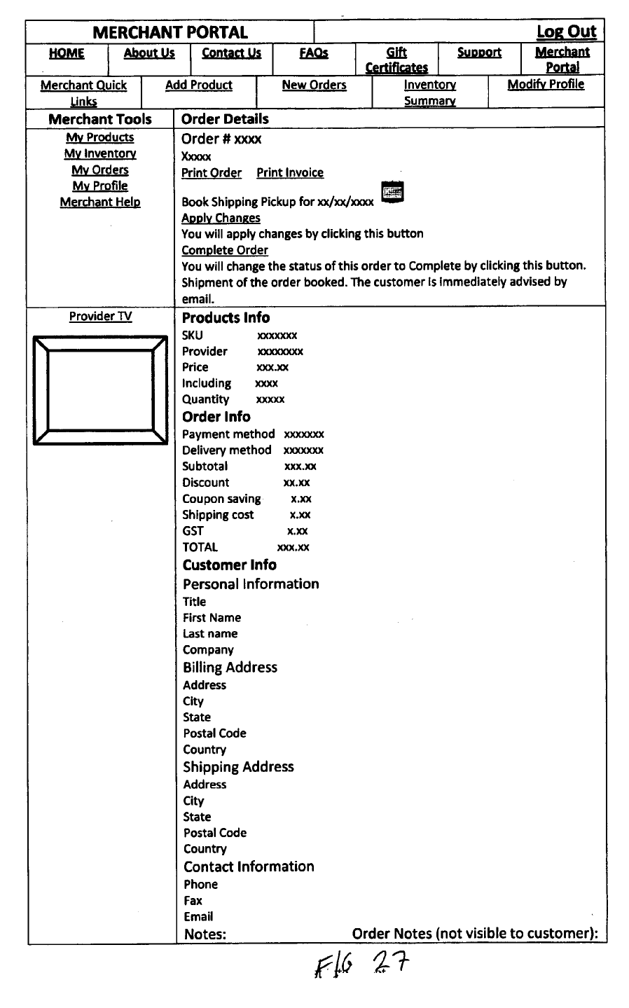

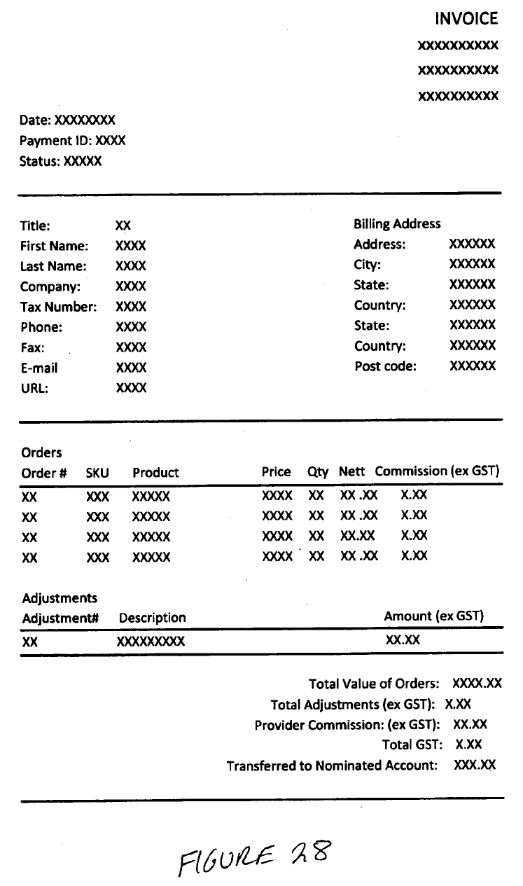

In FIG. 2, reference numeral 30 generally indicates the architecture of the system 10. The administrative module 12 includes a computer that is configured to generate a number of portals for use by merchants and buyers.

The portals can be grouped into two.

One group is an external group in the form of a shopping cart module 32 and comprises a buyer portal 34, a merchant portal 36 and a shopping cart portal 38. These each connect to the banking module 22, the database server 16 and a shipping, quoting and booking module hereinafter referred to as a shipping module 40.

The shopping cart module 32 is configured to provide shopping cart functionality to buyers and merchants. Thus, each merchant is able to upload data relating to goods or services for sale while buyers can use the module 32 to browse and select goods or services for purchase.

The shipping module 40 provides the necessary support and online infrastructure for delivery of goods or services to buyers in an automated manner. In order to achieve this, the shipping module 40 is configured to generate a shipping portal for use by a merchant using the system 10. The shipping module 40 is configured to provide buyers with quotes for shipments with varying delivery speeds. The module 40 also allows booking and tracking of shipments.

The banking module 22 is configured to provide for application and registration of merchants, pre-registration of buyer credit card information, purchase of products and dispersal of collected funds to the appropriate parties.

The other group is an internal group that defines a customer relations management (CRM) module 41 that comprises a provider portal 42, a “help” customer portal 44, and a “help” administration portal 46. These also each connect to the banking module 22, the database server 16 and the shipping module 40.

The CRM module 41 is configured to manage the merchant application process, the dispersal of funds, customer refunds, adjustments (including application of abnormal fees), a buyer/seller problem resolution interface and customer service management.

The provider portal 42 is generated by the administrative module 12 to allow for general administration of the system 10.

The help customer portal 44 is configured to facilitate access to help and support as described below under the heading Help/Support.

The groups 32, 40 are also in communication with each other via a suitable data pipe 48.

### Merchant Registration

In FIG. 3, reference numeral 50 generally indicates a flowchart of the steps carried out during registration of a merchant when using the system 10 for the first time, in accordance with a method of the invention.

The merchant uses the merchant portal 36 to apply online. On receipt, the application is processed by administrative staff logged into the shopping cart module 32. In the shopping cart module 32, a “lead” tab is provided which can be searched for those leads flagged as “new”. The process of generating the “lead” tab can be provided by an application such as that supplied by an organisation known as “Salesforce” and indicated by the “Lead” box in FIG. 31.

The merchant can use the merchant portal 36 to provide a document relating to terms and conditions of sale for approval by the provider.

The application is reviewed and the status of the lead is updated to “reviewing”. The provider then reviews the application using processes external to the computers of the system 10.

The provider automatically assigns a fee structure. If the application is successful, the administrative staff assigns the appropriate commission fee structure to the merchant in the CRM module 41 by editing a “fee structure” field associated with the lead represented by the merchant applying for the service.

The provider sends an email to the merchant. The status of the lead in the CRM module 41 is updated either to “Phase 1 Approved” or “Phase 1 Rejected”, depending on the result of the review. If approved, the e-mail is sent together with a bank application form in a suitable format.

The merchant is able to print the form and to fax it or email it to the provider that receives it at the CRM module 41. The status of the lead is updated to “Phase 2 Pending”. The form is received by a fax to scan application which automatically attaches the form to an email. The email is then sent automatically to the banking module 22 for processing.

The CRM module 41 can be configured to send a document automatically to the merchant applicant setting out terms and conditions with which the merchant is required to comply when transacting with buyers. The merchant can be required to agree with those terms and conditions as a condition for making use of the system 10.

At the banking module 22, the necessary credit and other checks are carried out and an approval or rejection email is sent back to the provider at the CRM module 41. If the e-mail is an approval e-mail, it is sent together with a suitable identification code.

At the shopping cart module, the staff update the records as “Phase 2 Approved” or “Phase 2 Rejected”. If approved, the identification code is entered against the merchant's record and a merchant account is created in the shopping cart portal 38. That account can be maintained by a third party as indicated in the box “Account” in FIG. 31. An approval email is sent to the merchant.

The CRM module 41 can be configured to maintain any number of merchant accounts in a contact database indicated by the box “Contacts” in FIG. 31.

Using the merchant portal 36, the merchant is able to navigate to an account activation page where the merchant can enter new login details and an email address. The shopping cart module 38 then sends an email to the merchant together with a token to direct the merchant to a page for activating the account. The merchant can then navigate to the page, change the password and login.

In FIG. 4, there is shown a flowchart which sets out the merchant registration process in more detail.

Initially, the merchant can navigate to a web form which is filled in and written to the shopping cart portal 38. The provider is able to assess the application and has an option to send out an e-mail declining the merchant's application. However, if the provider accepts the application, it can apply the fee structure and send an e-mail to the merchant notifying the merchant that the application is successful while also sending a bank application to the merchant.

The merchant faxes the application back to the provider and the fax to scan application attaches the fax as a PDF against an account generated by the shopping cart module 32 and associated with the merchant. An e-mail is then sent to the banking module 22 together with the PDF and a reference number. The banking module 22 can send an e-mail to the merchant declining the application. Alternatively, the banking module 22 can accept the application, in which case the shopping cart module 32 creates an account for the merchant and e-mails the merchant a username, password and a guide to using the shopping cart module 32.

It will be appreciated that this merchant registration process, which involves the banking module 22 and thus a bank, allows the provider to ensure that merchants are properly vetted and checked before they are able to use the system 10. Thus, the buyer is automatically protected without the need to personally check the merchant's credentials.

### Use of Buyer and Merchant Portals

In FIG. 5, reference numeral 60 generally indicates steps taken during the use of the buyer portal 34 and the merchant portal 36 at the shopping cart module 38.

The buyer portal 34 is configured to provide a checkout to which a buyer is directed once a product or service has been selected. Data relating to product dimensions, weight and packaging, buyer and merchant location and shipping preferences is written to the shipping module 40 that is configured to automatically produce quotes that are written to the buyer portal 34. The buyer then can select shipping options and complete the purchase. In one embodiment, the shipping module 40 is configured to present the buyer with three options in the form of the fastest quote, the cheapest quote and/or another quote falling in between the fastest and cheapest.

The buyer portal 34 can particularly be configured to permit buyers to select and purchase goods or services from a range of different merchants without having to change portals. It will be appreciated that the integration of the buyer and merchant portals 34, 36 into the shopping cart module 32 facilitates this functionality. Furthermore, the shopping cart module 32 can be configured such that the shipping module 40 comprises a number of different shipping portals to suit merchants with multiple warehouses requiring different shippers.

The buyer portal 34 is also configured to provide a link so that a buyer can download a copy of the document related to terms and conditions of sale associated with the merchant with whom the buyer wishes to transact. The document can be a standard document prepared and supplied by the provider. In another embodiment, the document can be provided by the merchant after having been approved by the provider, as described above.

The merchant portal 36 is configured to allow the merchant to process the order. In doing so, the merchant selects a date and a time for shipping pickup. The portal 36 generates a “book shipping” button which, when pressed by the merchant, sends data relating to the buyer's chosen quote and date and time for shipping pickup. The shipping is booked automatically by the shipping module 40. The shipping module 40 then generates a request number and a consignment note which are written to the merchant portal 36. The merchant prints the consignment note and completes order processing.

The merchant portal 36 can be configured to generate an inventory upload wizard to facilitate upload of inventory details by a merchant.

Also, the merchant portal 36 can be configured to integrate live feeds so that merchants can keep track of developments associated with the system 10.

The buyer portal 34 and the merchant portal 36 can communicate with the shipping module 40 to provide inventory tracking facilities available to the buyer and to the merchant.

The administrative module 12 is configured so that the merchant portal 36 defines a merchant dashboard for presentation to a merchant. A screenshot of the merchant dashboard is shown in FIG. 25. The merchant dashboard displays information relating to order numbers, buyers, total amounts, a “snapshot” of inventory and a “snapshot” of products. The dashboard also includes print buttons to allow a merchant to produce a printable screen of a particular order.

The snapshot of inventory displays:
items out of stock, including the number of product lines which have zero items available;
items with low stock, including the number of product lines which have less than a specified number of items available; and
recently added items, including the number of product lines in which the merchant has updated inventory in a predetermined previous period.

The snapshot of inventory displays both the number of products which fit in each of the above categories as well as providing an option for viewing a list of the relevant products.

The snapshot of products displays:
the number of products that the merchant has active in its account;
order tracking information with a “view” option to allow a merchant to view a tracking screen; and
recently deleted products which is the number of products that the merchant has removed from its account in the last predetermined time period.

The snapshot of products displays both the number of products in each category as well as providing an option for viewing a list of the relevant products.

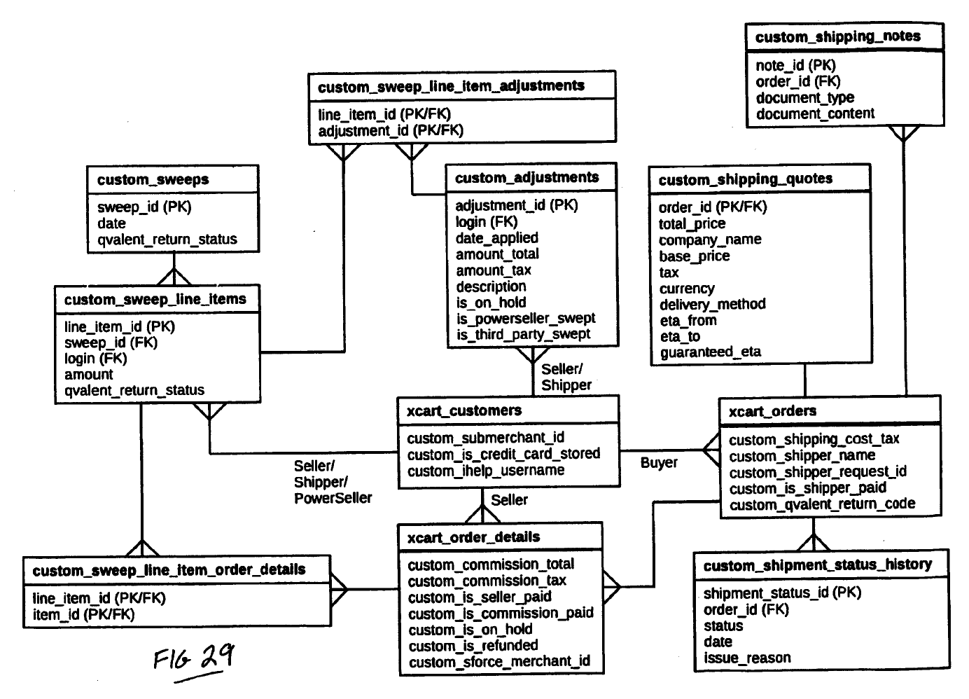

The merchant portal 36 is configured to generate an in-order details screen, an example of which is shown in FIG. 27, for viewing and interfacing with the merchant.

The in-order details screen is configured to display the following:
the date/time an order was made (and purchased);
navigation buttons for navigating to the previous and next order (if they exist);
the status of the order;
a Print Order button so that the merchant can view a printable screen with the order details;
a Print Invoice button to display a printable screen with an invoice for the buyer;
a Book Shipment button/drop-down box to set the date/time for shipment pickup and to display the chosen date and time (can include default values set to ‘tomorrow’ and ‘AM’);
an “Apply Changes” button to save customer/seller notes and to redisplay the screen;
a “Complete Order” button to book shipping, change the status of the order to “complete”, and e-mail the customer that the order has been processed;
a “Product Info” section, displaying, for each product purchased,
   a number and name of the product;
   a username of the seller;
   a price, including taxes, of the product;
   the amount of taxes the product attracts; and
   the quantity purchased of this particular product.
An “Order Info” section, displaying:
   the shipping company, and method of shipment;
   the subtotal, excluding shipping and taxes;
   discounts applied by the seller to this product;
   credit to this purchase made by the buyer using coupons;
   the cost of shipment, including taxes;
   taxes applied to the order; and
   the total amount of the order.
a “customer info” section, displaying:
   personal information; title, first and last name, company, and ABN;
   billing address including two address lines, city, state, postcode and country;
   shipping address;
   contact information; phone number, fax, website, e-mail address;
   notes made by the customer (editable); and
   notes made by the seller which are not visible to the customer (editable).

The merchant portal 36 is configured to generate a payments screen, an example of which is shown in FIG. 26.

The payments screen displays the payments made to the merchant by the provider as a result of concluded transactions. The screen displays the payments in a paginated list format which has the following columns:
the payment ID number;
date that the payment was made;
the total amount paid; and
an icon which is a link that, when followed, results in the browser downloading a PDF displaying an invoice, an example of which is shown in FIG. 28.

The “total paid” item refers to the total of all payments made to the merchant.

Clicking on any line item results in the display of all the orders which have been aggregated to form that particular payment.

It will be appreciated that further functionality can be added to the payment screen to allow a merchant to obtain further information relating to orders and purchases.

The invoice shown in FIG. 28 is generated by using the following fields:
a first section (payment details)
   date: date the payment was processed
   payment ID: unique identifying number for this payment
   status: will always be “paid”, since this invoice will only ever be viewable in that status
second section (merchant details)
   contact information: title, first and last names, company name, phone and fax numbers, e-mail address and URL
   billing address: address, city, state, country and postcode
Third section (order details): a list of all the order items which, aggregated together, are included in this payment. Order items are grouped into orders by leaving a larger space between orders than order items. The list has the following columns:
   Order #: this is the order number. Only the first order item in the order has this column populated.
   SKU: Unique number for the product that this order item represents.
   Product: Description of this product.
   Price: RRP of the product (including taxes).
   Qty: Quantity of the product ordered.
   Nett: Total value of the line item (i.e. Price multiplied by Qty)
   Commission (excluding taxes): provider commission charged on this line item, excluding taxes.
Fourth section (adjustments): a list of all the adjustments which are included in this payment. If there are no adjustments, this list (nor the headings) does not appear. The list has the following columns:
Adjustment #: Unique number representing this adjustment.
Description: Description of the type of adjustment.
Amount (excluding taxes): Amount of the adjustment, excluding GST. May be negative. (Negative values indicate a credit to the merchant from the provider).
Fifth section (totals/summary)
Total value of Orders: equal to the sum of the “Nett” column in the orders list.
Total Adjustments: equal to the sum of the “Amount (excluding taxes)” column in the adjustments list.
Provider Commission (excluding taxes): equal to the sum of the “Commission (excluding taxes)” column in the orders list.
Total taxes: total amount of taxes charged for all orders and adjustments making up this payment.
Transferred to nominated bank account DD-MMM-YYYY: date of transfer and amount transferred.

### Buyer Purchasing Process

In FIG. 6, there is shown a buyer purchasing process carried out by the system 10 and in accordance with a method of the invention.

The buyer accesses a portal or website operated by the provider. This links the buyer to the shopping cart portal where the buyer can enter credit card details in a secure manner. The merchant is notified of the transaction. The merchant then logs into the shopping cart portal to accept the order. The shipper is notified. The merchant receives a receipt and the consignment note from the shipping module. The merchant can then scan the goods and ship them to the buyer. When the goods arrive, the buyer can sign for them and a post-purchase process can be initiated. This will include a sweeping process described below.

### Post Shipping Process

In FIG. 7, there is shown a process, in overview, which takes place once the purchased products or goods have been shipped.

When the buyer accepts the goods, the shipper notifies the shopping cart portal electronically. The shopping cart module then automatically sends an e-mail to the buyer thanking the buyer for using the shopping cart portal. The shopping cart module then waits a period of seven days before marking the transaction as complete. This extent of time can be adjusted depending on requirements. A sweeping process described below is then initiated.

### Sweeping Process

In FIG. 8, there is shown an overview of a funds dispersal operation carried out by the banking module in order to disperse amounts paid by buyers to merchants, the shipper and the provider. The funds dispersal operation is carried out in response to data generated by a sweeping process carried out by the CRM module 41.

The sweeping process is also indicated broadly in FIG. 31.

Amounts paid by the buyer are received into a central holding account controlled by the provider that collects the funds in the holding account.

The CRM module 41 is configured to carry out the sweeping process on the holding account to generate dispersal instructions for the banking module so that the banking module can disperse the funds held in the holding account to various merchants, the shipper and the provider.

In FIG. 9, there is shown a flowchart of the overall sweeping process.

Sweeping occurs daily, in one embodiment. However, it will be appreciated that the sweeping process can occur at other predetermined intervals. It involves a compilation of a list of payees and the amounts to be paid to them, the generation of a data file for example in a CSV format to be sent to the banking module and processing the response from the banking module.

Compilation of the CSV file is carried out to permit the payment of different payees at different stages in the lifetime of a transaction. For example, the provider is paid its commission immediately, that is, when the credit card transaction has been completed. The shipper is paid when the shipping is booked by the merchant. The merchant is paid at least seven days after the product has been reported as delivered. As a result, the CRM module 41 is configured to record a status of all three of these transactions. It will be appreciated that these periods and conditions can be changed if required.

Initially, a provider commission is applied to each of the amounts paid into the holding account. The CRM module 41 proposes merchant, provider and shipper sweeps through the account. A cross check list of proposed sweeps is generated in the form of the data file described above. Administrative staff reviews the list and remove any problems. Thus, the data file is generated such that the administrative staff is able to drill down into each proposed sweep to uncover specific transactions. The CRM module 41 generates a data file such as a CSV file of approved sweep items. That file is then written to the banking module 22.

Some details of the manner in which the amounts relating to commissions are generated are shown below under the heading “Computer Program Code” and more specifically under the sub-heading “Commission Processing”.

It will be appreciated that the code displayed under the heading “Computer Program Code” is simply an example to indicate how the various processes described herein can be put into practice by a person of ordinary skill in the field. That code is not to be regarded as limiting in any way the functionality or scope of the description related to the accompanying drawings.

Reference in the code to “Powerseller” is to be regarded as reference to the provider.

Once the banking module has dispersed the amounts to the various parties in accordance with the approved sweep items, it generates a disbursement/exception report which is written to the CRM module 41. The CRM module 41 marks dispersed transactions as “paid” while holding problem transactions for investigation.

It will be appreciated that this process allows funds to be retained under escrow by a bank so that the consumers are protected with a money back guarantee. Disputes (over non delivery of goods or incorrect description of goods) can be resolved as part of this process (see FIGS. 22 and 23 under “Help/Support”. It follows that the provider can give protection to the buyer because it manages the payment and shipping process.

In FIG. 10, there is shown a flowchart of a process for calculating commissions to be paid to the provider.

Each transaction is examined at the CRM module 41. The provider fee is calculated if it has not already been saved. The fees are saved in the database server 16 against the associated transaction.

In FIG. 11, there is shown a flowchart of a process for proposing merchant sweeps. The CRM module 41 is configured to determine eligible merchant transactions and eligible adjustment transactions. The amount owing to each merchant is calculated. If a merchant is owed more than zero dollars, then the merchant is added to a list of proposed merchant sweeps. If not, the CRM module 41 does not conduct a sweep for the merchant in respect of the particular transaction.

In FIG. 12, there is shown a flowchart of a process for determining eligible merchant commissions. If it is determined that the merchant has already paid, then a particular transaction is marked as never eligible. If it is determined that the merchant has been refunded, then the transaction is marked as eligible. If not, then the transaction is marked as not eligible and to be checked on a following sweep if the product or service has been delivered and more than seven days has passed. Otherwise, the transaction is marked as eligible if there is no case open or on hold regarding a dispute or query in respect of that particular transaction. If the case is open or on hold, the transaction is marked as not eligible and to be checked on a following sweeps.

In FIG. 13, there is shown a flowchart of a process carried out at the CRM module 41 for determining whether or not certain adjustment transactions are eligible.

Adjustments are allowed for merchants and shippers. An adjustment is a payment made in the form of an ad hoc adjustment where provider administration needs to correct errors or a fee is charged to merchants and abnormal cases which are not product commission fees. Examples are a refund fee applied when a credit card refund is given to a buyer or a help fee if help is required to assist a transaction (see below under heading Help/Support)

The adjustments process is also represented as the box “Adjustments” in FIG. 31.

If an adjustment has not been paid and is not on hold then the transaction is not eligible. If an adjustment has been paid then the transaction is marked as never eligible. If the transaction is on hold, then the transaction is marked as not currently eligible and to be checked on a following sweep.

Adjustments are made by creating a new row in an appropriate database table. The sweeping process then handles the transaction as it sweeps through the database table.

In FIG. 14, there is shown a flowchart for calculating amounts owed to each merchant. The recommended retail price (RRP) of all eligible and non-refundable transactions is summed. Applicable provider commissions are subtracted and eligible adjustments are added or subtracted.

In FIG. 15, there is shown a flowchart for proposing shipper sweeps. The CRM module 41 is configured to determine eligible shipping transactions and eligible adjustment transactions and to calculate an amount owing to the shipper. If the shipper is not owed more than zero dollars, the CRM module 41 does not conduct a sweep for that shipper at that time.

In FIG. 16, there is shown a flowchart for determining eligible shipping transactions.

If the shipper has been paid, then the CRM module 41 marks the transaction as never been eligible. If the shipper has not been paid but the transaction is on hold, the CRM module 41 is marked as not currently eligible and to be checked again on a following sweep. If the transaction is not on hold and the shipping has been blocked then the transaction is marked as not currently eligible and to be checked again on a following sweep. If the shipping has not been blocked then the transaction is marked as eligible.

In FIG. 17, there is shown a flowchart for calculating an amount owed to a shipper. All eligible transactions are added. Eligible adjustments are added or subtracted to or from the summed amount.

In FIG. 18, there is shown a flowchart for proposing a provider sweep.

The CRM module 41 is configured to determine eligible commission transactions and eligible adjustment transactions. Then, an amount owing to the provider is calculated. If the provider is owed more than zero dollars, then the CRM module 41 does not conduct a sweep for the provider at that time.

In FIG. 19, there is shown a flowchart for determining whether or not commission transactions are eligible. If a commission has already been paid a transaction is marked as never been eligible. If a commission has not been paid but a transaction is on hold, the commission transaction is marked as not being currently eligible and to be checked again on a following sweep. Otherwise, the transaction is eligible.

In FIG. 20, there is shown a flowchart for calculating an amount owed to a provider. The product commissions of all eligible transactions are summed. Eligible adjustments are added or subtracted.

In FIG. 21, there is shown a flowchart for the administrative review of proposed sweeps. A list of a particular day's proposed sweeps is viewed to determine whether or not there are any problem transactions. If there are, those transactions are removed from the list and marked “on hold”. If not, the transactions are approved.

In another embodiment, the shipping sweep status can have its status updated from New to “Ready For Sweep” when a Shipping Status History record is generated against an order with a status “Awaiting Pickup” (this means that shipping has been booked). The merchant sweep status needs to have its status updated from New to “Ready For Sweep” seven days after the date set against a Shipping Status History record with the status “Delivered” against that order. It may be desirable to have the time (seven days) configurable for a shorter or a longer time under some circumstances.

It follows that the system will monitor a Shipping Status Object for the creation of new records. Upon a record being created that is Marked as “Awaiting Pickup” the system will update the Parent Object Shipping Status to “Ready for Sweep”.

Similarly, regarding updating a status of a merchant sweep, the system will monitor the Shipping Status Object for the creation of new records. Upon a record being created that is marked as “Delivered” the system will update the Order Lines attached to the parent object, setting the Merchant Sweep Date and Time to be the current system time plus a defined time period. This time period will be configurable by the system administrators. A batching system can be implemented that will set the Merchant Status to “Ready for Sweep” where the Merchant Sweep Date is less than or equal to the current system time.

### Help/Support

In FIG. 22, there is shown a first part of a process for performing help or support steps in accordance with a method of the invention.

In the buyer portal, the customer who is either a buyer or a merchant can select “help” or “support”. The customer is presented with a knowledge base. The customer is able to log a particular case. The help and administrative support shown at 24 in FIG. 1 is notified. The system generates a query as to whether or not the issue is a technical/accounts issue or is a product issue.

If the issue is a product issue an e-mail is sent to both the buyer and the merchant in order to initiate a conversation between the buyer and the merchant. If the merchant or seller offers a refund, the refund is processed and the case is closed. If the seller does not offer a refund and the case does not escalate, then the case remains open unless manually closed by the instigator.

If the case does escalate, a “help” service supplied by the CRM module 41 is notified. That service generates an invoice to be paid by the merchant. The health service contacts both the buyer and the merchant in order to arrange a resolution. If no resolution is reached, the merchant is refunded. If a resolution is reached, the refund is processed and the case is closed.

In FIG. 23, there is shown a second part of a process for performing help or support steps in accordance with a method of the invention.

If the issue is a technical/accounts issue then if the help and administrative support or customer service management (CSM) shown at 24 in FIG. 1 can help, then the CSM responds, adds the issue to the knowledge base and e-mails the customer with a solution.

If the CSM 24 is not able to help, then the CSM 24 escalates matter to staff on a technical/accounts team and e-mails the customer that the case has been escalated. The technical/accounts team is notified with the case details and CSM 24 comments. The technical/accounts team e-mails the solution to the CSM with advice as to whether or not to post it on the knowledge base. The CSM 24 then e-mails the solution to the customer.

### Refund Process

In FIG. 24, there is shown a flowchart indicating a refund process carried out in accordance with a method of the invention.

When a refund is requested, the refund amount is determined and a refund request is sent to the banking module 22. If the refund status is “success” the status of the particular refund request is marked as refunded and the refund is applied to the particular merchant. If not, the status is changed to “on hold”.

If a refund occurs before the shipping has been booked, the following payments are made:
the buyer is paid the RRP of the product plus the shipping fee
the provider is paid its usual commission plus a refund fee
the merchant is charged the provider's commission and the refund fee
the shipper is not paid.

If a refund occurs after the shipping is booked, the following parties are paid:
the buyer is paid the RRP of the product, but not the shipping fee
the provider is paid its usual commission plus a refund fee
the merchant is charged the provider's commission and the refund fee
the shipper is paid the shipping fee.

If a merchant has already been paid for the product (which can occur after the product is reported as delivered +7 days), then the provider does not handle any refund.

### Business Functionalities

The central functionality of the system 10 is associated with selling products of merchants to buyers and managing these transactions.

This involves the following procedures:
1. Merchant Registration. The merchant applies to be allowed to sell their products on the system 10.
2. Product Configuration. The merchant uploads their product details.
3. Buyer Purchase. The buyer browses and purchases a product.
4. Seller Processes Order. The seller is notified of the purchase and ensures shipment.
5. Package Tracking. The purchased product is tracked during shipment.
6. Funds Dispersal. Collected funds are dispersed to the appropriate parties.

A particular application of the system 10 is that it is able to provide a single platform supporting processes for both merchants and buyers. As a result, merchants and buyers can easily communicate with each other to achieve resolution on issues or cases that may arise. Furthermore, the single platform provides a mechanism which can be used by a merchant interfaced with a single portal. Thus, there is no need for the merchant to communicate separately with a shopping cart provider and a shipping provider. As a result, a merchant is able to register and conclude transactions in a cost effective and simple manner.

The provision of the single platform facilitates the ability to provide a source of knowledge or help at a single online location for both buyers and merchants.

Another feature of the single platform is the ability to retain and report on multiple transaction data against both buyers and merchants with the database. This information can be extracted from the shopping cart module at regular intervals.

The provision of the single platform facilitates the generation of a wide variety of reports. This allows the monitoring and analysis of orders, returns and re-orders. For example, the following reports can be generated by the administrative module whenever required:
daily and weekly transactions
transactions by merchants
highest and lowest transactions by volumes by merchant
highest and lowest transactions by value by merchant
average time between merchant being notified and when the merchant should be notified
longest merchant shippers
average time between shipper being notified and package arriving at destination by shipper
weekly reports on when funds will be cleared—based on delivery date of the package +7 days
margin breakdown reports on all fees being deducted, by fee
average response time for cases to be closed
number of cases that are escalated (per day, week)
average number of cases by merchant and buyer—to see what the average number of cases logged is for both merchants and buyers. If this case number is higher than a predetermined amount users may need to be educated on making the portals easier to use
top cases by buyer and merchant
daily sweeping and cross check reports
daily report of transactions not eligible for sweeping
average number of new merchant and buyers per week and month

### Account Management

The following is a description of the functionality afforded by the system 10 to the provider, the buyers, merchants, shippers any other parties who would use the system 10.

Create Account
On a home page, press the “I like to shop online; Register Now” button OR press the “Not a member? Register” button near the login box at the top of any screen.
Fill in application form, press Submit.
Buyer is now logged in.

Log in
Navigate to any screen (except Merchant portal and Admin portal).
At the top right hand corner of the screen, enter the username and password.
Press “Login”.

Log out
At the top right hand corner of a web form or page, press “Log out”.

Modify Account
Log into buyer account.
Press “My Account” button.
Change relevant detail(s).
Press “Submit” button.

Forgotten Password
Press “Forgot Password?” button on the login form.
Enter username and email address (which must match the email address in the account), press Submit.
Copy and paste URL in subsequent email into browser address bar (“unclickable” link).
Enter new password and confirm password, press “Submit”.
Log into account using the new password.

Search
Search by category
   Navigate to a shopping type screen (some checkout screens do not allow search by category directly).
   In the “Shop by category” section at the left of the screen, press a category to search.
   Press a sub-category to search.
   Relevant products are shown on the screen
Search by term
   Navigate to a shopping type screen (some checkout screens do not allow search by term directly).
   Type term into the search field.
   Press “magnifying glass”.
   Relevant products are shown on the screen.

Order by Product Name
Perform a search.
Press “Sort by Product”. Products are ordered by name in alphabetical order.

Order by Price
Perform a search (see above)
Press “Sort by Price”. Products are ordered by price in ascending order.
Ascending/Descending order
   Perform a search
   Press arrow button near “Sort by” options.
   Products are ordered in reverse direction to what they were previously.

Shopping Cart
Add product to cart
   Perform a search
   Select relevant product.
   Press “Add to cart”. Product is added to shopping cart.
Remove product from cart
   Ensure at least one product is in the shopping cart
   Navigate to shopping cart by pressing “Shopping Cart” button.
   Press “Delete item” against appropriate product.
   Product is removed from the shopping cart.

Wish list
Add product to wish list
   Search for a product.
   Select relevant product.
   Press “Add to wish list”.
View wish list
   When logged in as a buyer, press the “My Account” menu option.
   From the “My Account” side menu, select “Wish List”.
Remove product from wish list
   Ensure that at least one product is in the wish list.
   Navigate to wish list.
   Click “Delete Item” button of the relevant product.
Put product in wish list into cart
   Ensure that at least one product is in the wish list.
   Navigate to wish list.
   Click “Add to cart” button of the relevant product.

Orders
View/Print Orders/Invoices/Tracking Information
   Press “My Account” button.
   Press “Orders History” button.
   List of orders appears. Tracking information appears in the “Status” column, just underneath the status of the order.
   Click on order of interest.
   Invoice appears with information about the order.
   Click “Print Invoice”.
   Printable version of the invoice appears in browser. Use the browser printing function to print this page out.

Issue Management
Add to/initiate conversation with seller
Press “Support iHelp” menu option.
Insert details of issue
View conversation with seller
Request refund/intervention of Help and Support staff

### Merchant/Seller

The following is a description of the functionality of the system as offered to a merchant:

Registration
Go to Merchant Portal by pressing the “Merchant Portal” menu item.
Fill in form; press “Submit”.
Wait for email response from Provider Admin.
Print and fill out Bank Sub-Merchant Application form.
Fax form to provider.
Wait for email from provider Admin inviting the merchant to activate their new account.
Go to the account activation page mentioned in the email.
Enter email address.
Wait for automated email response giving a web page and a token for entering the first password.
Go to web page mentioned in email, enter token, press Submit.
Change password by entering new password and confirming that, press Submit.
Merchant is logged onto their account for the first time.

### Account Management

### Log in

Go to Merchant Portal by pressing the “Merchant Portal” button in the main menu.
Enter username and password.
Press “Log in”.

### Log out

At the top right hand corner of the screen, press “Log out”.

### Modify Account

When logged in, press either “Modify Profile” in the sub-menu at the top, or choose the “Your Profile” option in the side menu, followed by “Modify”.
Modify relevant details.
Press “Submit”.

### Product Configuration

Upload product by web form
   Log in as merchant.
   Click either the “Add Product” button in the Merchant Quick Links, or “Products” followed by “Add new product” in the side menu; or from the home page, click “Add new product”.
   Enter product details; press “Save”.
   Product is available on the website.
Upload product by file import
   Log in as merchant.
   Go to the home page by pressing “Home” from the main menu. Click “Import Products”.
   Nominate CSV file to upload.
   Press “Import” button.
   Products listed in the CSV file are uploaded and available on the website.
Search products
   When logged in as a merchant, press “Products” from the “Merchant Tools” side menu.
   Enter search terms.
   Press “Search” Button.
View products
   Perform a search for the relevant product
   Click the relevant product from the results of the search.
   Product information is displayed.
Modify products
   View the relevant product
   Update the relevant field of the product.
   Press the “Save” button.
Activate/deactivate products
   View the relevant product using the steps “View products”
   Change the “Availability” drop down list to “Available for sale” to activate, or “Disabled” to deactivate.
   Press the Save button.
Remove product
   Search for the relevant product(s) (see “Search products”)
   From the search result list, check the product(s) to be removed.
   Click the “Delete Selected” button.
   Product(s) will be removed.

### Orders

View orders and tracking information
   When logged in as a merchant, press the “Orders” option from the “Merchant Tools” side menu, followed by “Search for Orders”.
   Enter appropriate search criteria for the target order.
   Press “Search”.
   Information about the order including tracking information is displayed in the “Status” column, underneath the status of the order.
   Select the appropriate order to be viewed.
   Information about that specific order is displayed.
Book shipping
   View the appropriate order (see above). This order must not have already had shipping booked.
   Complete the order by pressing “Complete order”.
   Against “Booking for pickup”, select date and time, and press adjacent button.
   Shipping is booked; Booking request ID is displayed.
Print consignment note
   View the appropriate order (see above).
   Ensure that shipping is booked for the relevant order (see above)
   Press the button adjacent to “Print consignment note”.
   PDF is downloaded by browser; consignment note is printable from the user's preferred PDF viewer.

### Payments to Merchant by Provider

View Payments
   When logged in as a merchant (see above), in the Merchant Tools side menu, press “Orders”, then “Your Payments”.
   Payments are listed.
View Provider Tax Invoice
   View payments (see above)
   Press the icon in the “Invoice” column of the relevant payment.
   Invoice is presented as a PDF file.
Issue Management
   Add to/initiate conversation with seller
   View conversation with seller
   Request refund/intervention of help and support staff

### Shopping Cart Administration Staff

Account Administration
Log in
   Go to Administration Portal by navigating to a website hosted by the provider. (Note, this must be done from a configured IP address).
   Enter username and password.
   Press “Log in”.
Log out
   At the top right hand corner of the screen, press “Log out”.
Create Account
   Log into shopping cart administration portal.
   Click “Management” in the side menu, followed by “Users”.
   Depending on the role being created, press one of “Create administrator profile”, “Create provider (merchant) profile” or “Create customer profile)”.
   Fill in form with profile data.
   Press “Save”.
   Account is created.
Modify Account
   When logged into the shopping cart portal, on the side menu, press “Management”, then “Users”.
   Press the “Search for users” button.
   Enter search filter expressions, press “Search”.
   Click on relevant username.
   Modify relevant information, press “Submit”.
   User information is modified.
Delete Account
   Perform the first three steps in “Modify Account”.
   Check the checkbox against the username(s) to be deleted.
   Press the “Delete Selected” button.
   Account(s) are deleted.
Enable/Disable Account
   Perform the first three steps in “Modify Account”.
   Check the checkbox against the username(s) to be enabled/disabled.
   For the dropdown box entitled “Suspend/enable login for accounts”, select either “suspend” or “enable” as required.
   Press “Submit”
   Accounts are enabled or disabled as directed.

View Order and Tracking information
When logged into the shopping cart, in the side menu, press “Management” and then “Orders”.
Enter search filter expressions, press “Search”.
Tracking information is displayed in the “Status” column, underneath the drop down box.
Featured Products/Merchants Management
Manage Featured Products on Front Page
   When logged into the shopping cart administration portal, in the side menu, press “Management” and then “Categories”. The “Featured Products” section is at the bottom of this page.
   Click the “Browse” button next to the text field under the “Add product” section.
   In the popup window that comes up, select the category that the product to be featured comes under and press “Show Products”.
   Select the relevant product from the list on the right hand side of the popup window.
   Click the “Select” button.
   In the “Position” field, enter a number which represents where on the front page the product to be featured will be. The lower the number, the higher up the position will be.
   Click the “Add new” button.
   Product will then be in the “Featured Products” section on the front page of the site in the position relative to the other featured products.
Manage Featured Merchants
   Follow the steps to modify the target merchant's account.
   At the bottom of the “Modify provider profile” page, set the “Featured Merchant” drop down box to “enabled”, or “disabled” as required.
   The featured merchant will appear on the front page with their logo displayed. Clicking that logo will display all products being offered by that merchant. There are only five slots, so to ensure that the correct merchants are being displayed, set only five merchants to “enabled”.

Category Management
Add Category
   When logged into the shopping cart portal, in the side menu, press “Management” and then “Categories”.
   Enter details, then press “Save”.
   If the new category is intended to be a sub-category of another category, then scroll to the bottom of the page, select the parent category and press “Update”.
Edit Category
   When logged into the shopping cart administration portal, in the side menu, press “Management” and then “Categories”.
   Select target category by clicking the radio box directly to the left of the category name, press “Modify selected”.
   Modify appropriate details, then press “Save”.
   To edit a sub-category, click on the name of the parent category. This will bring up a similar list of sub-categories which can then be modified as described above.
Remove Category
   When logged into the shopping cart administration portal, in the side menu, press “Management” and then “Categories”.
   Select target category by clicking the radio box directly to the left of the category name, press “Delete selected”.
   A warning will appear describing all products and sub-categories which will also be deleted if the current category is deleted. Press “Yes” to confirm the delete or “No” to abort.
   To delete a sub-category, click on the name of the parent category. This will bring up a similar list of sub-categories which can then be deleted as described above.

### Provider Administration Staff

Administer Merchant Applications

The following use cases are required to administer merchant applications. This is described in detail with reference to FIG. 3.
View Applications
Approve/Decline applications, Phase 1.
Assign fee structure
Attach forms to application
Send application to bank/Start Phase 2.
Enter Sub-merchant ID
Create Merchant account
Complete application

### Sweeping

The following describes how to perform sweeping. This is described with reference to FIGS. 8 to 21 and with reference to the code appearing under “Computer Program Code” below. A proposed sweep file is created to be sent to the banking module 22. This file is not automatically sent. The administrative module 12 checks that it is correct before it is sent to the banking module 22. The administrative module 12 is configured so that once it has received a sweep file; it will not be possible for the administrative module 12 to generate a new sweep file until the following day.

The method is as follows:
go to a “sweep manager” tab
press “sweep” button
   View On Hold Transactions (problem transactions)
   Approve On Hold Transactions for next sweep
   View Proposed Sweep
Go to “Sweeps” tab
Click on a Sweep Number associated with the sweep that needs to be viewed. Note that a “Sweep Date” column can be used for selecting the right sweep.
A resultant page displays the information about the sweep. Note that when a sweep is created, this page is automatically displayed for the new sweep.
“Sweep Merchant Roll-Ups” is generated to indicate aggregated payments that will be made to the indicated merchants. Commission payments to the provider are indicated. Shipping payments to a shipper are indicated. All other items are payments to merchants for their products. To scrutinize a payment, an associated “Sweep Merchant Roll-Up Number” can be selected.
A resultant page gives details about the payment to a specific merchant. The Sweep Line Items indicate each item making up the aggregated payment to the merchant. Each Sweep Line Item may be scrutinized by clicking on the associated “Sweep Line Item Number”.
A resultant page gives details about a specific Line Item payment to a specific merchant.
   Put transaction on hold from proposed sweep
Drill down to the target Sweep Line Item by following steps described above for viewing a Proposed Sweep.
The Sweep Line Item may be cancelled from the current sweep by pressing a “Cancel Record” button. This removes this Line Item from the current sweep and places that Order Item “On Hold”.
Enter a reason for cancelling the transaction.
A new Case is created automatically to allow management of the problematic transaction.

The following is an alternative method for putting a transaction on hold from a proposed sweep: (Note, if a Sweep has already been proposed, the above method is used instead)
Search for the target Merchant.
Click the target Order number.
Click the target Order Item within that order.
Edit the Order Item (click “Edit”)
Change “Status” to “On Hold”
Press Save.
It is advisable to create a new Case at this stage to allow proper management of the problematic transaction.
   View details of transaction (orders within the transaction)
   Approve “on hold” transactions for sweeping
Search for the target merchant
Click the target order number
Click the target order item within that order
Edit the order item, for example by clicking “edit”
Change “status” to “ready for sweep”
Press Save
It is advisable to update the associated case for this transaction at this stage to allow proper management of the problematic transaction
This transaction will be available for sweeping the next time a sweep is proposed (see “create sweep”)
   Approve Sweep
go to “sweeps” tab
click on the sweep number associated with the sweep that needs to be approved. Note that a “sweep date” column is useful for selecting the right sweep
click “send sweep to the bank”
click “send it to bank”
success or failure of transmission of the file to the bank is then indicated
Manage Problems
Unacknowledged orders
   This occurs when a seller fails to process orders within an acceptable timeframe
Cases escalated from Help process.
On Hold Transactions
   “On Hold” transactions are those which have been put on hold from sweeping manually due to external problems.

### Orders

View Orders
Initiate Refund

### Buyer/Merchant Account Administration

View Account
Modify Account
Activate/Suspend/Disable Account

### Staff Account Management

Create/Modify/Delete/Activate/Disable Account
Reports
View/Print Reports
Adjustment transactions
Apply adjustment transaction to merchant
Help and Support Staff
View Issues
Raise Issue
Escalate Issue
Close Issue

### Failure Use Cases

### Merchant Registration

Merchant declined by Provider
   During Merchant Registration, provider Admin staff select “Phase 1 Rejected”.
   Email is sent to merchant informing that they have had their application declined by the Provider.
Merchant declined by Bank
During Merchant Registration provider Admin staff select “Phase 2 Rejected”.
Email is sent to merchant informing that they have had their application declined by the bank.

### Buyer Purchase

Credit Card details invalid
   During Buyer Purchase, buyer enters invalid credit card details.
   Error message appears; buyer invited to try again.
Card expired
   During Buyer Purchase, buyer enters expired credit card details.
   Error message appears; buyer invited to try again.
Purchase declined
   Buyer makes a purchase. The credit card details are correct, but there is a problem; for example insufficient funds.
   Purchase is stopped, buyer asked to contact the bank. The reason is not provided since the reason might be because of suspected fraud.

### Seller Processes Order

Seller fails to process order
   Order appears as a “Problem Order” to admin staff
   Admin staff initiate a refund
   Seller charged penalty fee
Seller orders shipment, but package isn't ready when shipping carrier arrives

### Package Tracking

Shipping carrier fails to deliver package within promised time range
   Buyer raises issue using Help and Support functionality
   problem solving process deals with the problem

### Funds Dispersal

Provider administration staff removes problem transaction (described above with reference to the sweeping process).
Sweep response indicates errors
   Problem transactions are automatically marked as “On Hold”.
   Provider admin staff view “On hold” transactions.

### General

Invalid input into web-forms
   Data is not processed.
   Web form reappears populated with already filled-in data.
   Invalid data is highlighted with a relevant message explaining the problem.
Compulsory fields not completed
   Data is not processed.
   Web form reappears populated with already filled-in data.
   Empty field is highlighted with a message explaining that this field is compulsory.
Invalid input in file imports
Page not found
   Error page appears complete with normal theme and usual headers, footers and menus.
   Error is explained in plain English.
PHP Error
   Error page appears complete with normal theme and usual headers, footers and menus.
   The error message explains that there is a technical problem, but no technical details are explained.
   Technical details of the error are logged.
   Email to support

### Shopping Cart Software Features Provided

The following is a list of features that are provided with the shopping cart module. Items marked with a “Y” are configured for the provider, while those marked with “X” are not and can form part of an existing software cart application. A “P” indicates that the feature can be configured for use by the provider.

### Setup and Support

Y Complete store-builder package
Y Easy-to-use web interface
P Export of store data: config data, states, users, categories, products, destination zones, taxes, shipping rates, orders, membership levels, etc.
P Import of store data: config data, states, users, categories, products, destination zones, taxes, shipping rates, membership levels, etc.
Y Out-of-the-box storefront system
X Customizable localization: multi-language, configurable currency symbol and weight/dimension measurement units, configurable list of states/provinces
Y Free access to all future releases

### Design and Layout

Y W3C XHTML 1.0 Transitional compliant code
Y Intuitive navigation
P CKEditor, TinyMCE, and InnovaStudio WYSIWYG editors for product/category/manufacturer descriptions, language variables and static pages
Y Automated product thumbnails generation with a sharpness filter
Y Category thumbnail images
X AJAX-powered “mini-cart” visible on all pages
P Flyout and expanding Categories menu
P Build-in template editor: preview, edit and restore templates
Y WYSIWYG text editor (webmaster mode)
X Debug console: displays a tree of templates for all pages
X The possibility to find, create and modify static HTML pages
X Customizable heading tabs
Y HTML emails

### Customer Care

Y All orders stored in MySQL database
Y Customers can search & browse personal order history
P Integrated configurable store product search
Y Real time order tracking
X Customer can choose between account registration and express checkout
X Fast Lane Checkout module for quick and intuitive checkout
X The possibility to disable checkout without registering
P Password reminder for customers
X Customizable e-mail notifications/invoices
P Wish list
P “Send to friend” section
Y Ability to save the customer's cart
P Newsletter management for multiple lists, edit/import/export of subscribers, news archive for customers
P Printable versions of pages
X Multiple customer types with unique pricing for every customer type
X Memberships and special pricing
Y “Clear cart” button
P Edit product options in cart/wishlist/Gift registry wishlist
Y Printable invoices
Y Configurable contact form
Y Second address line for user profiles
Y Ability to change the order of products on the customer side

### Product (Goods) Catalogue

Y Unlimited number of products
Y Unlimited number of categories
X Unlimited category nesting
Y Products can be assigned to unlimited number of categories
Y Ability to modify multiple products simultaneously
P Members-only categories
Y “Featured Products” box
Y Automated display of bestsellers
Y Related products, up selling and cross selling
X 1-click enable/disable switch for products and categories
X Support for up to two different currencies in the products catalogue (NOTE: payment processing is possible in one currency only)
X Automatic currency conversion
Y Configurable search by title, description, category, SKU, price and weight
Y “Stop words filter” for product search facility (a special filter ensures that service and link words occurring in the search pattern are ignored when search by individual words is performed—available for English language only)

### Product Details

Y Unlimited product options/variants/properties w/optional price modifiers
Y Unlimited custom input fields for products
P Customer-defined prices
Y HTML-enriched product descriptions
Y Unlimited number of product images
P Storing images in DB or on a file system
Y List a product in several categories
Y Manufacturers module
P Ability to display product detailed images in popup windows

### Merchandising and Inventory

x Discount coupon codes and gift certificates
Y Full inventory control
Y “Out of Stock” Messages
Y Quantity discounts
Y Retail and wholesale price
Y Limit minimal order amount

### Shipping and Tax

Y Real-time USPS, FedEx and UPS shipping calculation from one location
X Unlimited number of custom-defined delivery methods
X Flat rate, weight, order total and per-item based shipping
X Different weight limits for different delivery methods
X Mark-ups for real-time shipping
X Mark your products as “free shipping” products
X Promotional “free shipping” coupons to your customers
P Add handling/freight charges
P Handle international, domestic and local shipping
X Ability to clone a zone and all zone information
X Restrict shipping by location
Y Allow your customers to choose delivery methods
P Support for downloadable goods (e-goods)
X Customizable tax calculation
X Product-specific taxes
P Taxes & shipping fees depending on client's location
X “Tax exempt” feature
X GST/PST (Canadian tax system)
X Canada post shipping
X DHL (Airborne) ShipIt API support
X Australia Post's Delivery Rate Calculator support
X Shipping Label Generator for USPS and UPS
X Postal order tracking

### Sales Analysis and Tracking

Y Comprehensive statistics:
Y—Number of orders
Y—Number of customers
Y—Product views
Y—Category views
Y—Products removed from cart by customers
Y—Sales by product/best sellers
Y—Total sales
Y—Client environment settings
Y—Statistics on search patterns customers use when searching products
Y Searchable order data
Y Order data is easy to print
Y History of order changes
Y Quick order/product/user search panel on a keyboard shortcut
Y Printable shipping labels
X Automatic creation of shipping labels for orders intended to be shipped by USPS and UPS
Y Search engine & incoming traffic tracker: the cart keeps referrer data for all customers
Y Shipment/fulfilment interface
Y Export sales & customer data for use in a spread sheet
Y Export orders to QuickBooks format

### Payment Gateways and Methods

X Accept payments in any currency
X Allow payment via several online payment modules
X Payment systems (including PayPal payments) x High variety of real-time credit card processors (over 100 payment gateways)
X Cheque processors x Manual (offline) credit card processing
X PayPal payments
X Google Checkout as an alternative to X-Cart's standard checkout
X Predefined set of payment methods (offline): cheques, purchase orders, phone orders, wire transfer and etc.
P Authorize/Capture processing mode for several payment gateways

### Search Engine Optimization

Y Pages can be indexed by all major search engines
Y Custom META tags for product, category and static pages
Y Custom URLs for product, category and static pages
Y Customer referrer info is stored in database
Y Product catalogue can be generated as static HTML pages for better website performance
Y Search engine optimization options group
Y Page contents is placed at the top of the page HTML-code
Y Search Engine Friendly URLs for product, category and static pages

### Database and Platform Compatibility

Y Open source PHP code
P Support for UNIX/Linux, Windows and Mac OS X servers Y Powered by MySQL database
X Multi-language: your e-store can work with unlimited number of languages
X Multi-lingual products
X Multi-lingual categories
X Multi-lingual product options
X Payment processing modules for all major gateways
Y Flexible implementation: you can easily add new features and/or disable existing ones.

### Repeat Customer Accommodation

Y All customers' data is stored in database
Y Greet regular visitors
Y Registered customers can be offered discounts
Y Registered customers do not have to enter their data again
Y Registered customers can edit their profile
Y Registered customers can access history of their orders
Y Built-in newsletter engine
Y Export of newsletter subscribers
Y Real-time order tracking for registered customers
Y Moderated product reviews and ratings
X Return Merchandise Authorization add-on to return customers' payments.

### Web Based Control Panel

Y Password-protected administrative access
Y All changes are real-time
X Control the cart from anywhere in the world using your web browser
Y Unlimited number of admin accounts
X Support for restricted “shipping/fulfilment” admin accounts
Y User-defined date/time format
Y Ability for administrator to act on behalf of other users (e.g. to place phone orders for customers and use X-Cart as web based point of sale system)

### Security

Y Full HTTPS/SSL support
Y Secure HTTPS/SSL administrative access
Y Password-protected administrative access
Y Strong Blowfish encryption for sensitive customer data
P PGP-encrypted e-mail notifications
Y Real-time security notifications of all failed login attempts
P Anti-Fraud module validates customer's address during checkout
Y Stop list module allows disabling shop usage from specific IP
Y Backup sub-system
Y System fingerprints: ability to compare the status of the store files before and after modification and to discover which files have been deleted, added or modified
Y Protect registration pages and e-mail forms with a random-number image

### Computer Program Code

Below follow code snippets from a computer program for implementing at least part of the sweeping process, including the adjustment processes, as described above.

### Commission Processing

The following describes an example of coding used to adjust commissions to the provider

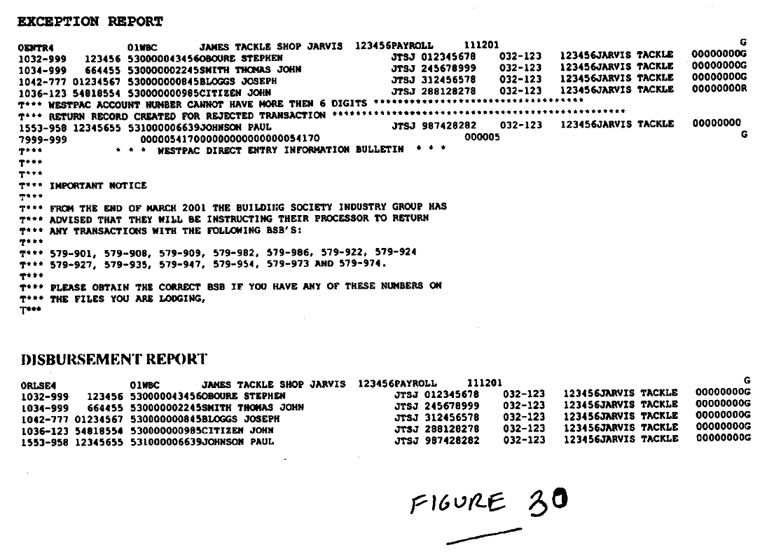

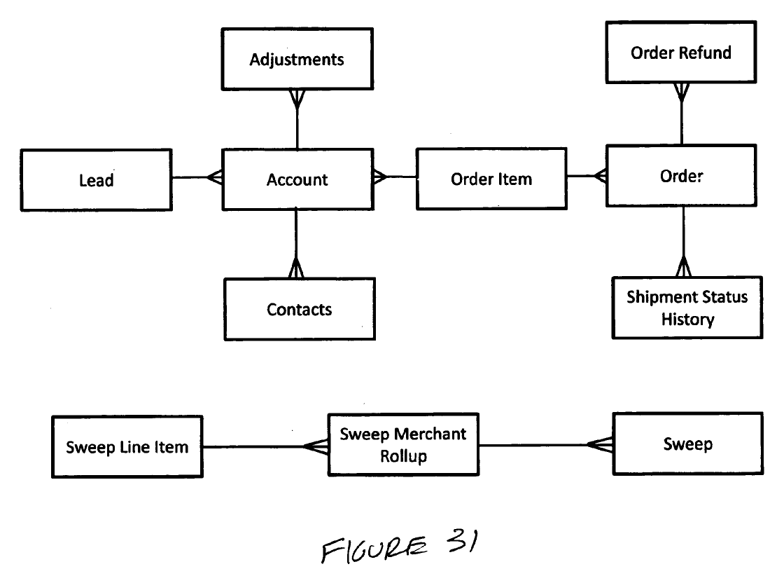

Referring to FIG. 29, a database schema is shown for a database used by the system 10, in which primary keys are indicated by “PK” and foreign keys are indicated by “FK”. Those tables and items incorporating “xcart” indicate parts of the schema and thus the system 10 that can be administered by a third party shopping cart provider. In this example, that provider is one known as “Xcart”. Those tables and items incorporating “custom” indicate parts of the schema and thus the system 10 that are administered in accordance with the invention. As is apparent, those parts or processes relate to the sweeping described above, adjustments and aspects of shipping. It follows that the database schema illustrates how the system 10 can be integrated with an existing shopping cart application.

Table: xcart_customers

This table includes records for storing details about users of the system, including information about buyers, sellers, and shippers.

Required extra columns:
custom_is_credit_card_stored: Yes/No—Flag to show if buyer's credit card information has been stored on the banking module
custom_submerchant_id:—Variable—The submerchant ID supplied by a bank to be used to indicate the beneficiary when conducting a sweep.
custom_ihelp_username:—Variable—This is a username generated by the administrative module to allow single sign on at the iHelp portal. It identifies which customer is using the portal.
   Table: xcart_orders

This table is for storing information about each attempted order. Note that if an order is attempted and fails (for example, insufficient funds on the credit card), this is also recorded. A buyer can have zero or more orders.

Required extra columns:
custom_shipper_name:—Variable—The name of the shipper used.
custom_shipper_request_id:—Variable—Shipper booking ID.
custom_is_shipper_paid:—Yes/No—Has the shipper been paid (i.e. has their component of the order been swept successfully)
custom_qvalent_return_code:—Variable—The return code from the banking module after attempting to charge the buyer's credit card, and could indicate either success or failure.
   Table: xcart_order_details

This table is for storing information about each item in an order. An order can have one or more order details. A seller is related to zero or more order details.

Extra columns required:
custom_price_tax:—Currency—As above, except the tax applied
custom_commission_total:—Currency—The Powerseller commission applied to this item, including taxes.
custom_commission_tax:—Currency—As above, except the tax applied.
custom_is_seller_paid:—Yes/No—Flag if the seller has been paid (i.e. had their component of the order swept successfully)
custom_is_commission_paid:—Yes/No—Flag if the service provider's commission has been paid
custom_is_on_hold:—Yes/No—Has this item been put on hold for any reason?
custom_is_refunded:—Yes/No—Has this item been refunded successfully?
custom_sforce_merchant_id:—Variable—Reserved for system processing.
   Table: custom_shipment_status_history

This table provides a shipment history to each order. As it reaches another stage, another entry is added to the table. Each order has zero or more entries in this table.

Required columns:
shipment_status_id (PK): Integer—ID for each shipment status history record.
order_id (FK): Integer—Foreign key to xcart_orders.
Status: This is an enumerated type which indicates one of: Awaiting Pickup, Picked up, Delivered, Issue. Issue. “Awaiting Pickup” means that shipping has been booked and is currently awaiting pickup by the shipper. “Picked up” means the shipper has picked up the item. “Delivered” means the shipper has delivered the item. “Issue” means that there is a problem with the shipment. The details of this problem is given in the issue_reason column below.
Date: DateTime—The date and time the status was applied. The status with the latest date/time is the currently applicable status.
Issue_reason: This gives the reason for the shipment issue if there is one. This column is only populated if the status is “Issue”.
   Table: custom_sweeps

Each time a sweep is made (instructions given to bank to pay outstanding amounts to merchants and shippers), information about the sweep is recorded here.

Required columns:
sweep_id (PK): Integer—Unique ID for each sweep.
date: DateTime. The date and time of the sweep.
qvalent_return_status: Variable—Overall return status of the entire transaction. It is possible that even if this is successful, individual entries in the sweep may fail.
   Table: custom_sweep_line_items

This table is for storing information about each line item in the sweep, including the beneficiary and the amount. A beneficiary may be a seller, shipper, or the service provider. Each sweep may have one or more line items. Each line item is an aggregation of one or more order details, and zero or more adjustments.

Required columns:
line_item_id (PK): Unique ID for each line in a sweep.
sweep_id (FK): Foreign key to custom_sweeps.
login (FK): Foreign key to xcart_customers.
amount: Amount provided to beneficiary.
qvalent_return_status: Return status from the banking module regarding this particular beneficiary. Always recorded, regardless of a success or failure.
   Table: custom_sweep_line_item_order_details

The relationship between sweep line items and order details is many-to-many. Each line item in the sweep may be an aggregation of many order details. Further, a single order detail may be split up into payments for several beneficiaries. This table merely makes this many-to-many relationship possible.

Required columns:
line_item_id (PK/FK): Integer—Foreign key to custom_sweep_line_items.
item_id (PK/FK): Integer—Foreign key to xcart_order_details.
   Table: custom_adjustments

Adjustments are irregular transactions applied to a third party (merchant or shipper), for example exceptional fees or credits where mistakes have been identified. A positive adjustment indicates a payment to the third party from the provider, and a negative adjustment indicates a payment from the third party to the provider.

Required columns:
adjustment_id (PK): Integer—Unique ID for each adjustment.
login (FK): Variable—Foreign key to xcart_customers.
date_applied: Date/Time—Date that the adjustment is applied.
amount total: Currency—Amount of the adjustment including tax. Can be negative.
amount tax: Currency—Tax applicable to the above amount. Can be negative.
description: Variable—Description of the adjustment.
is_on_hold: Yes/No. Is this adjustment on hold for any reason?
is_powerseller_swept: Yes/No. Has this adjustment been successfully swept to the provider?
is_third_party_swept: Yes/No. Has this adjustment been successfully swept to the third party?
   Table: custom_sweep_line_items_adjustments

The relationship between sweep line items and adjustments is many-to-many. Each line item in the sweep may be an aggregation of many adjustments. Further, a single adjustment may be related to two line items (eg the third party and service provider). This table merely makes this many-to-many relationship possible.

Required columns:
line_item_id (PK/FK): Integer—Foreign key to custom_sweep_line_items.
adjustment_id (PK/FK): Integer—Foreign key to custom_adjustments.
   Table: custom_shipping_quotes

This table is used to store a shipper quotation that a buyer has accepted. This information will be used when the seller books a shipper using this quotation.

Required columns:
order_id (PK/FK): Integer—Foreign key to xcart_orders.
total_price: Currency—This is the total price of the shipping quote, including tax.
company_name: Variable—Name of the shipper.
base_price: Currency—Price of the shipping quote, excluding tax.
tax: Currency—Tax component of the shipping quote.
Currency: Variable—Code representing the currency of the price; e.g. AUD
delivery_method: Variable—Description of the method of delivery.
eta_from: Integer—Lower bound of estimated delivery time in number of days.
eta_to: Integer—Upper bound of estimated delivery time in number of days.
guaranteed_eta: Yes/No. Are the delivery times guaranteed?
   Table: custom_shipping_notes

This table is used to store shipping consignment notes, which are issued by the shipping module when shipping is booked.

### Required Columns:

note_id (PK): Integer—Unique ID for each consignment note
order_id (FK): Integer—Foreign key to xcart_orders
document_type: Variable—MIME type of the document.
document_content: Text—Content of the document.

The system 10 is particularly well-suited as an adjunct for bank systems, via the banking module 22. That module allows the provider to partner with one or more banks to provide the security of online bank transactions to merchants and buyers. Not only does this benefit the merchants and buyers through increased security and efficient settlement of disputes, but it also provides a means whereby banks can better establish relationships with clients without the need for those clients to experience dealing with banks, which can often seem overly bureaucratic.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:

There is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1. An electronic transaction system for facilitating electronic transactions between merchants and buyers, the system comprising:
a shopping cart module configured for providing a merchant portal for merchants to display details of goods for sale and to provide a buyer portal for buyers to select and purchase the goods;
a shipping module configured for providing buyers automatically with details of a shipping service of at least one shipper for shipping the goods selected for purchase by the buyer, and to communicate shipping orders automatically to the at least one shipper following checkout of goods for purchase by the buyer;
a banking module configured for providing a payment gateway for facilitating distribution and transfer of funds amongst merchants, shippers, and a system provider; and
an administration module configured for executing a merchant registration process for enabling a merchant to register with the system provider, in which the registration process with the system provider includes automatically registering an account for the merchant with both the shopping cart module and with the payment gateway.

2. An electronic transaction system as claimed in claim 1, in which the administration module is configured so that the merchant registration process can include receiving merchant application information from a web form, storing the merchant application information in a database, associating a fee structure with the merchant application information and writing at least the merchant application information to the banking module.

3. An electronic transaction system as claimed in claim 2, in which the administration module is configured so that information about a commission based fee structure is generated and assigned to the merchant application information, and information about the commission based fee structure and a request form for information needed for registration with the payment gateway is written to a merchant computer.

4. An electronic transaction system as claimed in claim 3, in which the administration module is configured so that the information needed for registration with the payment gateway can be received from the merchant computer, and application information for registration of the merchant with the payment gateway can be written to the banking module for processing.

5. An electronic transaction system as claimed in claim 4, in which the administrative module is configured for receiving a merchant identification code from the banking module which has been generated in response to approval of the new merchant application information for registration of the merchant with the payment, gateway to store the merchant identification code in relation to the merchant information in the database and to create an account for the merchant with the shopping cart module.

6. An electronic transaction system as claimed in claim 5, in which funds paid for goods and services purchased by buyers are deposited into a central funds holding account, the administration module including a sweeping module which is configured for executing a sweeping process which includes retrieving information about the commercial transactions from the database module, determining the distribution amounts of funds from the central holding account to the merchants, shippers, and the e-commerce service provider, and compiling payment instructions for forwarding to the banking module for distributing funds oer the payment gateway.

7. An electronic transaction system as claimed in claim 6, in which the sweeping module is configured for compiling payment instructions for merchants, shippers, and the provider, at different times in the transaction process.

8. An electronic transaction system as claimed in claim 7, in which the sweeping module is configured for determining eligibility of payment of any one of the merchant, shipper, and the provider before executing the sweeping process in relation to transactions relating to any one of the merchant, shipper, and the provider respectively.

9. An electronic transaction system as claimed in claim 8, in which the administrative module is configured for flagging a merchant as eligible for payment after goods that are purchased from the merchant are delivered and the database module is updated to indicate that the goods are delivered.

10. An electronic transaction system as claimed in claim 8, in which the administrative module is configured for flagging a shipper as eligible for payment after a merchant confirms the order for shipment with the shipper and the database module is updated to indicate that shipment of goods is confirmed.

11. An electronic transaction system as claimed in claim 10, in which the administrative module is configured for flagging the provider as eligible for payment after funds for a transaction are received in the central funds holding account.

12. An electronic transaction system as claimed in claim 8, in which the sweeping module is configured for generating a data file that includes the payment instructions, information in the data file being presentable on a user interface for review by a user, and for editing by a user with the administration module prior to writing the data file to the banking module.

13. An electronic transaction system as claimed in claim 1, which includes a customer relations module that is configured for providing a communication pathway between merchants and buyers to facilitate the resolution of disputes that arise between merchants and buyers the customer relations module being configured for generating and managing an issue resolution process for resolving issues between merchants and buyers, the process including:
receiving information from a buyer about the issue, and filtering the information to determine if the issue is technical, product, or account related;
sending the information to a computer associated with a support staff member; and
establishing the communications pathway for sending information between the relevant merchant and buyer.

14. An electronic transaction system as claimed in claim 1, in which the administrative module is configured for interfacing with the shipping module for generating information about tracking progress of shipment of purchased goods.

15. A method for facilitating electronic transactions between merchants and buyers, the method comprising the steps of:
with a shopping cart module, providing a merchant portal for merchants to display details of goods for sale and a buyer portal for buyers to select and purchase the goods;
with a shipping module, providing buyers automatically with details of a shipping service of at least one shipper for shipping the goods selected for purchase by the buyer, and writing shipping orders automatically to the at least one shipper following checkout of goods for purchase by the buyer;
with a banking module, providing a payment gateway for facilitating distribution and transfer of funds amongst merchants, shippers, and a system provider; and
with an administration module, executing a merchant registration process for enabling a merchant to register with the system provider, such that the registration process with the system provider includes automatically registering an account for the merchant with both the shopping cart module and with the payment gateway.

16. A computer-readable medium tangibly embodying instructions executable by a processor for facilitating commercial transactions between merchants and buyers, the instructions comprising instructions for:
with a shopping module, providing a merchant portal for merchants to display details of goods for sale and a buyer portal for buyers to select and purchase the goods;
with a shipping module, providing buyers automatically with details of a shipping service of at least one shipper for shipping the goods selected for purchase by the buyer, and writing shipping orders automatically to the at least one shipper following checkout of goods for purchase by the buyer;
with a banking module, providing a payment gateway for facilitating distribution and transfer of funds amongst merchants, shippers, and a system provider; and
with an administration module, executing a merchant registration process for enabling a merchant to register with the system provider, such that the registration process with the system provider includes automatically registering an account for the merchant with both the shopping cart module and with the payment gateway.
